(19) United States
(12) Patent Application Publication
(10) Pub. No.: US 2024/0394769 A1
(43) Pub. Date: Nov. 28, 2024

(54) DATA-DRIVEN AUTOMATED VISUAL CONFORMANCE ESTIMATION FOR COMPLEMENTARY ITEM DISCOVERY IN E-COMMERCE

(71) Applicant: eBay Inc, San Jose, CA (US)

(72) Inventors: Berkan Solmaz, San Jose, CA (US); Antonio Haro, Walnut Creek, CA (US)

(21) Appl. No.: 18/202,277

(22) Filed: May 25, 2023

(51) Int. Cl. G06Q 30/0601

(52) U.S. Cl. CPC G06Q 30/0629

(57) ABSTRACT

A system may identify a set of items depicted within a set of images, where the set of items are associated with a first product category and a second product category of an online marketplace. The system may determine a complementary category relationship between the first and second product categories based on a relative frequency that items associated with the first and second product categories are depicted together within the set of images. The system may receive a query image depicting a query item associated with the first product category, and may utilize the complementary category relationship to identify and recommend items of the second product category that are complementary (e.g., visually and stylistically complementary) to the query item.

### FIELD OF TECHNOLOGY

The present disclosure relates generally to database systems and data processing, and more specifically to data-driven automated visual conformance estimation for complementary item discovery in e-commerce.

### BACKGROUND

Online marketplaces may use a variety of techniques to recommend items or products to users. Recommended products may include products explicitly queried or requested by the user, and/or products that are “complementary” to (e.g., related) to queried products. For example, if a user submits a query for “sofa,” an online marketplace may present the user with product listings for other sofas, as well as other complementary items related to sofas that the user may be interested in, such as coffee tables, throw pillows, etc. Some systems may be configured to identify complementary items based on titles of the items, item descriptions, and the like. However, such titles and item descriptions are often input by respective sellers, and may therefor vary widely between users, and may be ambiguous or misleading.

### SUMMARY

A method is described. The method may include identifying, using one or more processors, a set of multiple items depicted within a set of multiple images, where the set of multiple items are associated with a first product category and a second product category of a set of multiple product categories of an online marketplace, determining, using the one or more processors, a complementary category relationship between the first product category and the second product category based on a relative frequency that items associated with the first product category and the second product category are depicted together within the set of multiple images, receiving, from a client device, a query image depicting a query item associated with the first product category of the set of multiple product categories, identifying that the first product category is complementary to the second product category of the set of multiple product categories based on the complementary category relationship, identifying a first set of items associated with the first product category that are depicted within the set of multiple images and that are visually similar to the query item, identifying, based on the second product category being complementary to the first product category, a second set of items associated with the second product category that are depicted together with the first set of items within the set of multiple images, and transmitting, to the client device in response to the query image, a search result that indicates one or more complementary items associated with the second product category that are available for purchase from the online marketplace, where the one or more complementary items comprise one of more of the second set of items, or one of more items visually similar to the second set of items.

An apparatus is described. The apparatus may include at least one processor, at least one memory coupled with the at least one processor, and instructions stored in the at least one memory. The instructions may be executable by the at least one processor to cause the apparatus to identify, using one or more processors, a set of multiple items depicted within a set of multiple images, where the set of multiple items are associated with a first product category and a second product category of a set of multiple product categories of an online marketplace, determine, using the one or more processors, a complementary category relationship between the first product category and the second product category based on a relative frequency that items associated with the first product category and the second product category are depicted together within the set of multiple images, receive, from a client device, a query image depicting a query item associated with the first product category of the set of multiple product categories, identify that the first product category is complementary to the second product category of the set of multiple product categories based on the complementary category relationship, identify a first set of items associated with the first product category that are depicted within the set of multiple images and that are visually similar to the query item, identifying, base at least in part on the second product category being complementary to the first product category, a second set of items associated with the second product category that are depicted together with the first set of items within the set of multiple images, and transmit, to the client device in response to the query image, a search result that indicates one or more complementary items associated with the second product category that are available for purchase from the online marketplace, where the one or more complementary items comprise one of more of the second set of items, or one of more items that are visually similar to the second set of items.

Another apparatus is described. The apparatus may include means for identifying, using one or more processors, a set of multiple items depicted within a set of multiple images, where the set of multiple items are associated with a first product category and a second product category of a set of multiple product categories of an online marketplace, means for determining, using the one or more processors, a complementary category relationship between the first product category and the second product category based on a relative frequency that items associated with the first product category and the second product category are depicted together within the set of multiple images, means for receiving, from a client device, a query image depicting a query item associated with the first product category of the set of multiple product categories, means for identifying that the first product category is complementary to the second product category of the set of multiple product categories based on the complementary category relationship, means for identifying a first set of items associated with the first product category that are depicted within the set of multiple images and that are visually similar to the query item, means for identifying, based on the second product category being complementary to the first product category, a second set of items associated with the second product category that are depicted together with the first set of items within the set of multiple images, and means for transmitting, to the client device in response to the query image, a search result that indicates one or more complementary items associated with the second product category that are available for purchase from the online marketplace, where the one or more complementary items comprise one of more items of the second set of items, or one of more items that are visually similar to the second set of items.

A non-transitory computer-readable medium storing code is described. The code may include instructions executable by a processor to identify, using one or more processors, a set of multiple items depicted within a set of multiple images, where the set of multiple items are associated with a first product category and a second product category of a set of multiple product categories of an online marketplace, determine, using the one or more processors, a complementary category relationship between the first product category and the second product category based on a relative frequency that items associated with the first product category and the second product category are depicted together within the set of multiple images, receive, from a client device, a query image depicting a query item associated with the first product category of the set of multiple product categories, identify that the first product category is complementary to the second product category of the set of multiple product categories based on the complementary category relationship, identify a first set of items associated with the first product category that are depicted within the set of multiple images and that are visually similar to the query item, identifying, base at least in part on the second product category being complementary to the first product category, a second set of items associated with the second product category that are depicted together with the first set of items within the set of multiple images, and transmit, to the client device in response to the query image, a search result that indicates one or more complementary items associated with the second product category that are available for purchase from the online marketplace, where the one or more complementary items comprise one of more items of the second set of items, or one or more items that visually similar to the second set of items.

Some examples of the method, apparatuses, and non-transitory computer-readable medium described herein may further include operations, features, means, or instructions for determining a set of multiple appearances that indicate how often items associated with the respective set of multiple product categories may be depicted within the set of multiple images and determining the relative frequency that items associated with the first product category and the second product category may be depicted together within the set of multiple images based on normalizing the set of multiple appearances, where determining the complementary category relationship may be based on the relative frequency.

Some examples of the method, apparatuses, and non-transitory computer-readable medium described herein may further include operations, features, means, or instructions for generating, using a machine learning model, one or more data objects that indicate a set of multiple relative frequencies that items of respective pairs of product categories of the set of multiple product categories may be depicted together within the set of multiple images, the set of multiple relative frequencies including the relative frequency between the first product category and the second product category and referencing the one or more data objects based on receiving the query image, where identifying that the first product category may be based on referencing the one or more data objects.

Some examples of the method, apparatuses, and non-transitory computer-readable medium described herein may further include operations, features, means, or instructions for determining a set of multiple complementary category relationships between the first product category and other product categories of the set of multiple product categories, the set of multiple complementary category relationships including the complementary category relationship, determining a set of multiple scores associated with the set of multiple complementary category relationships, where the set of multiple scores may be associated with relative strengths of relationships between the first product category and the other product categories of the set of multiple product categories, and selecting the complementary category relationship from the set of multiple complementary category relationships based on the set of multiple scores, where identifying the first set of items and the second set of items may be based on the complementary category relationship.

In some examples of the method, apparatuses, and non-transitory computer-readable medium described herein, the complementary category relationship between the first product category and the second product category may be associated with a higher score as compared to an additional complementary category relationship between the first product category and a third product category based on items of the first product category being depicted together with items of the second product category more frequently than items of the third product category.

In some examples of the method, apparatuses, and non-transitory computer-readable medium described herein, the complementary category relationship may be further generated based on purchasing history information associated with a relative frequency that items of the first product category and items of the second product category may be purchased together via the online marketplace.

In some examples of the method, apparatuses, and non-transitory computer-readable medium described herein, the first set of items may be visually similar to the query item based on the first set of items satisfying one or more visual similarity criteria and the one or more visual similarity criteria include a color criteria, a stylistic criteria, a texture criteria, or any combination thereof.

Some examples of the method, apparatuses, and non-transitory computer-readable medium described herein may further include operations, features, means, or instructions for determining one or more user preferences of a user associated with the client device, where identifying the second set of items may be based on the one or more user preferences.

Some examples of the method, apparatuses, and non-transitory computer-readable medium described herein may further include operations, features, means, or instructions for receiving, from the client device, a request for complementary items associated with a third product category, identifying, based on the request, a third set of items associated with the third product category that may be depicted together with the first set of items within the set of multiple images, and transmitting, to the client device in response to the query image, the search result that indicates one or more additional complementary items associated with the third product category that may be available for purchase from the online marketplace, where the one or more additional complementary items comprise one or more items of the third set of items, or one or more items that are visually similar to the third set of items, or both.

Some examples of the method, apparatuses, and non-transitory computer-readable medium described herein may further include operations, features, means, or instructions for receiving, via the client device, a selection of a complementary item of the one or more complementary items associated with the second product category, identifying a third set of items associated with the second product category that may be depicted within the set of multiple images and that may be visually similar to the complementary item, identifying, based on the second product category being complementary to a third product category, a fourth set of items associated with the third product category that may be depicted together with the third set of items within the set of multiple images, and transmitting, to the client device based on the selection, an additional search result that indicates one or more additional complementary items associated with the third product category that may be available for purchase from the online marketplace, where the one or more additional complementary items comprise one or more of the fourth set of items, or one or more items that are visually similar to the fourth set of items, or both.

A method is described. The method may include identifying a set of multiple items depicted within a set of multiple images, where the set of multiple items are associated with a first product category and a second product category of a set of multiple product categories of an online marketplace, determining a complementary category relationship between the first product category and the second product category based on a relative frequency that items associated with the first product category and the second product category are depicted together within the set of multiple images, receiving, from a client device, a query image depicting a query item associated with the first product category of the set of multiple product categories, identifying that the first product category is complementary to the second product category of the set of multiple product categories based on the complementary category relationship, identifying a first set of items associated with the first product category that are depicted within the set of multiple images and that are visually similar to the query item, identifying, based on the second product category being complementary to the first product category, a second set of items associated with the second product category that are depicted together with the first set of items within the set of multiple images, and transmitting, to the client device in response to the query image, a search result that indicates one or more complementary items associated with the second product category that are available for purchase from the online marketplace, where the one or more complementary items comprise one or more items of the second set of items, or one or more items that are visually similar to the second set of items.

An apparatus is described. The apparatus may include at least one processor, at least one memory coupled with the at least one processor, and instructions stored in the at least one memory. The instructions may be executable by the at least one processor to cause the apparatus to identify a set of multiple items depicted within a set of multiple images, where the set of multiple items are associated with a first product category and a second product category of a set of multiple product categories of an online marketplace, determine a complementary category relationship between the first product category and the second product category based on a relative frequency that items associated with the first product category and the second product category are depicted together within the set of multiple images, receive, from a client device, a query image depicting a query item associated with the first product category of the set of multiple product categories, identify that the first product category is complementary to the second product category of the set of multiple product categories based on the complementary category relationship, identify a first set of items associated with the first product category that are depicted within the set of multiple images and that are visually similar to the query item, identify, based on the second product category being complementary to the first product category, a second set of items associated with the second product category that are depicted together with the first set of items within the set of multiple images, and transmit, to the client device in response to the query image, a search result that indicates one or more complementary items associated with the second product category that are available for purchase from the online marketplace, where the one or more complementary items comprise one or more items of the second set of items, or one or more items that are visually similar to the second set of items, or both.

Another apparatus is described. The apparatus may include means for identifying a set of multiple items depicted within a set of multiple images, where the set of multiple items are associated with a first product category and a second product category of a set of multiple product categories of an online marketplace, means for determining a complementary category relationship between the first product category and the second product category based on a relative frequency that items associated with the first product category and the second product category are depicted together within the set of multiple images, means for receiving, from a client device, a query image depicting a query item associated with the first product category of the set of multiple product categories, means for identifying that the first product category is complementary to the second product category of the set of multiple product categories based on the complementary category relationship, means for identifying a first set of items associated with the first product category that are depicted within the set of multiple images and that are visually similar to the query item, means for identifying, based on the second product category being complementary to the first product category, a second set of items associated with the second product category that are depicted together with the first set of items within the set of multiple images, and means for transmitting, to the client device in response to the query image, a search result that indicates one or more complementary items associated with the second product category that are available for purchase from the online marketplace, where the one or more complementary items comprise one or more items of the second set of items, or one or more items that are visually similar to the second set of items.

A non-transitory computer-readable medium storing code is described. The code may include instructions executable by a processor to identify a set of multiple items depicted within a set of multiple images, where the set of multiple items are associated with a first product category and a second product category of a set of multiple product categories of an online marketplace, determine a complementary category relationship between the first product category and the second product category based on a relative frequency that items associated with the first product category and the second product category are depicted together within the set of multiple images, receive, from a client device, a query image depicting a query item associated with the first product category of the set of multiple product categories, identify that the first product category is complementary to the second product category of the set of multiple product categories based on the complementary category relationship, identify a first set of items associated with the first product category that are depicted within the set of multiple images and that are visually similar to the query item, identify, based on the second product category being complementary to the first product category, a second set of items associated with the second product category that are depicted together with the first set of items within the set of multiple images, and transmit, to the client device in response to the query image, a search result that indicates one or more complementary items associated with the second product category that are available for purchase from the online marketplace, where the one or more complementary items comprise one or more items of the second set of items, or one or more items that are visually similar to the second set of items.

### BRIEF DESCRIPTION OF THE DRAWINGS

FIG. 1 illustrates an example of a complementary item discovery methodologies system that supports data-driven automated visual conformance estimation for complementary item discovery in e-commerce in accordance with aspects of the present disclosure.

FIG. 2 shows an example of a flowchart that supports data-driven automated visual conformance estimation for complementary item discovery in e-commerce in accordance with aspects of the present disclosure.

FIGS. 3 and 4 show examples of data objects that support data-driven automated visual conformance estimation for complementary item discovery in e-commerce in accordance with aspects of the present disclosure.

FIG. 5 show an example of an item recommendation diagram that support data-driven automated visual conformance estimation for complementary item discovery in e-commerce in accordance with aspects of the present disclosure.

FIG. 6 shows an example of a process flow that supports data-driven automated visual conformance estimation for complementary item discovery in e-commerce in accordance with aspects of the present disclosure.

FIG. 7 shows a block diagram of an apparatus that supports data-driven automated visual conformance estimation for complementary item discovery in e-commerce in accordance with aspects of the present disclosure.

FIG. 8 shows a block diagram of an item recommendation component that supports data-driven automated visual conformance estimation for complementary item discovery in e-commerce in accordance with aspects of the present disclosure.

FIG. 9 shows a diagram of a system including a device that supports data-driven automated visual conformance estimation for complementary item discovery in e-commerce in accordance with aspects of the present disclosure.

FIG. 10 shows a flowchart illustrating a method that supports data-driven automated visual conformance estimation for complementary item discovery in e-commerce in accordance with aspects of the present disclosure.

### DETAILED DESCRIPTION

Online marketplaces may use a variety of techniques to recommend items or products to users. Recommended products may include products explicitly queried or requested by the user, and/or products that are “complementary” to (e.g., related) to queried products. For example, if a user submits a query for “sofa,” an online marketplace may present the user with product listings for other sofas, as well as other complementary items related to sofas that the user may be interested in, such as coffee tables, throw pillows, etc. Some systems may define “complementary items” as items that have been purchased together by other users. However, such a definition may restrict the quantity and variety of complementary items that may be recommended to users. Other systems may be configured to identify complementary items based on titles of the items, item descriptions, and the like. However, such titles and item descriptions are often input by respective sellers, and may therefore vary widely between users, and may be ambiguous or misleading. As such, complementary items identified based on item titles and item descriptions may be unreliable, or irrelevant to the respective query items. Moreover, even in cases where complementary items are sufficiently related to a respective query item, the color or style of the returned complementary items may clash with, or otherwise not conform with, the respective query item. For example, a user that submits an image of a “minimalist sofa” is unlikely to purchase ornately embroidered throw pillows, even though “throw pillows” are technically a complementary item to “sofas.”

Accordingly, aspects of the present disclosure are directed to techniques for identifying complementary products and product categories based on how frequently respective products/product categories are depicted together in images. In particular, the techniques described herein may be used to identify related product categories based on how frequently items of the respective product categories are depicted together in images, and use the related product categories to provide more appropriate and visually appealing complementary products in response to received queried products.

For example, machine learning models may be configured to perform object detection to identify items within images, such as images retrieved from publications, webpages, social media platforms, and the like. The machine learning models may then be configured to identify “complementary category relationships” between different product categories based on how frequently items of the respective product categories are depicted together within the images. In particular, product categories of items that are frequently depicted together may be associated with complementary category relationships with higher strengths or scores as compared to product categories that are rarely depicted together.

For instance, a complementary category relationship between “sofas” and “coffee tables” may be associated with a higher score as compared to “sofas” and “gardening equipment” due to the fact that sofas are more frequently pictured with coffee tables as compared to gardening equipment. In some cases, purchasing history of items may also be used to generate the complementary category relationships (e.g., the system identifies a relationship between “sofas” and “coffee tables” based on users previously purchasing sofas and coffee tables together).

Continuing with reference to the same example, a user may subsequently submit a query image of a sofa as a query item. In this example, the system may identify complementary product categories based on the generated complementary category relationships. For example, the system may determine that “tables” are the most relevant or complementary product category for “sofas.” As such, the system may identify sofas within the images that are most visually similar to the sofa from the query image. The system may then identify tables that are depicted together with the most visually similar sofas, and may then provide product listings for the identified tables (or other tables that are visually similar to the identified tables) as recommended complementary products for the sofa from the query image.

By identifying complementary category relationships based on how frequently different types of items are shown together within a same image(s), the system may be able to identify the most relevant, or most complementary, types of items that users are likely searching for. In other words, upon receiving a query depicting a sofa, the complementary category relationships may enable the system to determine that the user is most likely searching for (or most likely would be interested in) complementary tables, pillows, chairs, and curtains, etc. Moreover, by identifying items that are visually similar to queried items, and subsequently identifying complementary items that are pictured with such visually similar items, techniques described herein may enable the system to return complementary items that are not only relevant/related to the queried items, but that are also more likely to aesthetically and stylistically complement the queried item. In other words, the complementary tables recommended to the user in the example above may exhibit styles, colors, and textures that complement the style, color, and textures of the queried sofa.

Aspects of the disclosure are initially described in the context of an environment supporting an on-demand database service. Additional aspects of the disclosure are described in the context of an example flowchart, an example item recommendation diagram, example data objects, and an example process flow. Aspects of the disclosure are further illustrated by and described with reference to apparatus diagrams, system diagrams, and flowcharts that relate to data-driven automated visual conformance estimation for complementary item discovery in e-commerce.

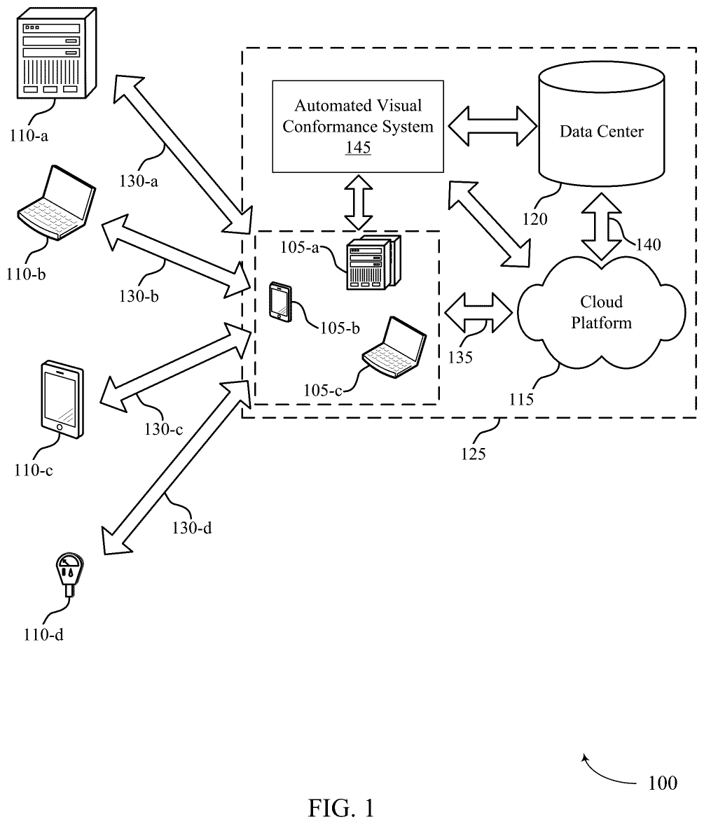

FIG. 1 illustrates an example of a system 100 for cloud computing that supports data-driven automated visual conformance estimation for complementary item discovery in e-commerce in accordance with various aspects of the present disclosure. The system 100 includes cloud clients 105, contacts (e.g., client devices 110), cloud platform 115, an automated visual conformance system 145, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a computing device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts (e.g., client devices 110). The interactions 130 may include communications, opportunities, purchases, sales, or any other interaction between a cloud client 105 and a client device 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Client devices 110 may interact with the cloud client 105 in person or via phone, email, web, text messages, mail, or any other appropriate form of interaction (e.g., interactions 130-a, 130-b, 130-c, and 130-d), which may include network-based communications (e.g., messages transmitted via, and received from, a network). The interaction 130 may be a business-to-business (B2B) interaction or a business-to-consumer (B2C) interaction. A client device 110 may also be referred to as a customer, a potential customer, a lead, a client, or some other suitable terminology. In some cases, the client device 110 may be an example of a user device, such as a server (e.g., client device 110-a), a laptop (e.g., contact 110-b), a smartphone (e.g., contact 110-c), or a sensor (e.g., client device 110-d). In other cases, the client device 110 may be another computing system. In some cases, the client device 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a client device 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a client device 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, an automated visual conformance system 145, and data center 120. In some cases, data processing may occur at any of the components of subsystem 125, or at a combination of these components. In some cases, servers may perform the data processing. The servers may be a cloud client 105 or located at data center 120. In some aspects, the automated visual conformance system 145 may be included within, or implemented by, an online marketplace (e.g., electronic marketplace. Moreover, in some aspects, the automated visual conformance system 145 may be communicatively coupled to the various components of the subsystem 125 (e.g., cloud clients 105, cloud platform 115, data center 120), and may be configured to perform one or more of the steps, operations, or functions described herein.

As described previously herein, online marketplaces may use a variety of techniques to recommend items or products to users. Recommended products may include products explicitly queried or requested by the user, and/or products that are “complementary” to (e.g., related) to queried products. For example, if a user submits a query for “sofa,” an online marketplace may present the user with product listings for other sofas, as well as other complementary items related to sofas that the user may be interested in, such as coffee tables, throw pillows, etc. Some systems may define “complementary items” as items that have been purchased together by other users. However, such a definition may restrict the quantity and variety of complementary items that may be recommended to users.

Other systems may be configured to identify complementary items based on titles of the items, item descriptions, based on pre-defined manual attributes, and the like. However, such titles and item descriptions are often input by respective sellers, and may therefore vary widely between users, and may be ambiguous or misleading. Moreover, defining complementary items according to pre-defined manual attributes may require manual supervision and labeling, which may be exhaustive and time consuming, may require expert level knowledge for consistent annotation, and may not be scalable for diverse datasets. Further, such manual labeling may result in category-specific labels and complementary relationships, which may not be scalable across other categories for unseen labels. As such, complementary items identified based on item titles and item descriptions may be unreliable, or irrelevant to the respective query items. Moreover, even in cases where complementary items are sufficiently related to a respective query item, the color or style of the returned complementary items may clash with, or otherwise not conform with, the respective query item. For example, a user that submits an image of a “minimalist sofa” is unlikely to purchase ornately embroidered throw pillows, even though “throw pillows” are technically a complementary item to “sofas.”

Accordingly, aspects of the system 100 shown and described in FIG. 1 may support techniques for identifying complementary products and product categories based on how frequently respective products/product categories are depicted together in images. In particular, the automated visual conformance system 145 of the system 100 may support techniques that may be used to identify related product categories based on how frequently items of the respective product categories are depicted together in images, and use the related product categories to provide more appropriate and visually appealing complementary products in response to received queried products. In particular, for items belonging to categories such as home decoration and fashion, visual attributes may be more helpful or descriptive for determining complementary items as compared to co-purchased item information, where functionality may be the focus. As such, techniques described herein may utilize visual similarity and conformance to drive complementary item recommendations.

For example, the automated visual conformance system 145 of the subsystem 125 associated with an online marketplace may utilize or implement machine learning models to perform object detection to identify items within images, such as images retrieved from publications, webpages, social media platforms, and the like. The machine learning models may then be configured to identify “complementary category relationships” between different product categories based on how frequently items of the respective product categories are depicted together within the images. In particular, product categories of items that are frequently depicted together may be associated with complementary category relationships with higher strengths or scores as compared to product categories that are rarely depicted together.

For instance, a complementary category relationship between “sofas” and “coffee tables” may be associated with a higher score as compared to “sofas” and “gardening equipment” due to the fact that sofas are more frequently pictured with coffee tables as compared to gardening equipment. In some cases, purchasing history of items may also be used to generate the complementary category relationships (e.g., the automated visual conformance system 145 implemented by an online marketplace identifies a relationship between “sofas” and “coffee tables” based on users previously purchasing sofas and coffee tables together).

Continuing with reference to the same example, a client device 110 may subsequently submit a query image of a sofa as a query item to the automated visual conformance system 145 associated with the online marketplace. In this example, the automated visual conformance system 145 may identify complementary product categories based on the generated complementary category relationships. For example, the automated visual conformance system 145 may determine that “tables” are the most relevant or complementary product category for “sofas.” As such, the automated visual conformance system 145 may identify sofas within the images that are most visually similar to the sofa from the query image. The automated visual conformance system 145 may then identify tables that are depicted together with the most visually similar sofas, and may then provide product listings for the identified tables (or other tables that are visually similar to the identified tables) to the client device 110 as recommended complementary products for the sofa from the query image.

By identifying complementary category relationships based on determining what types of items are frequently shown together, the system 100 (e.g., automated visual conformance system 145) may be able to identify the most relevant, or most complementary, types of items that users are likely searching for. In other words, upon receiving a query depicting a sofa, the complementary category relationships may enable the system to determine that the user is most likely searching for (or most likely would be interested in) complementary tables, pillows, chairs, and curtains, etc. Moreover, by identifying items that are visually similar to queried items, and subsequently identifying complementary items that are pictured with such visually similar items, techniques described herein may enable the system 100 to return complementary items that are not only relevant/related to the queried items, but that are also more likely to be aesthetically and stylistically complement the queried item. In other words, the complementary tables recommended to the user in the example above may exhibit styles, colors, and textures that complement the style, color, and textures of the queried sofa.

Techniques described herein may improve the quality of complementary items recommended to users. In particular, aspects of the present disclosure may utilize visual similarity and visual conformance in order to recommend complementary items of other categories that visually and stylistically match or complement queried items.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

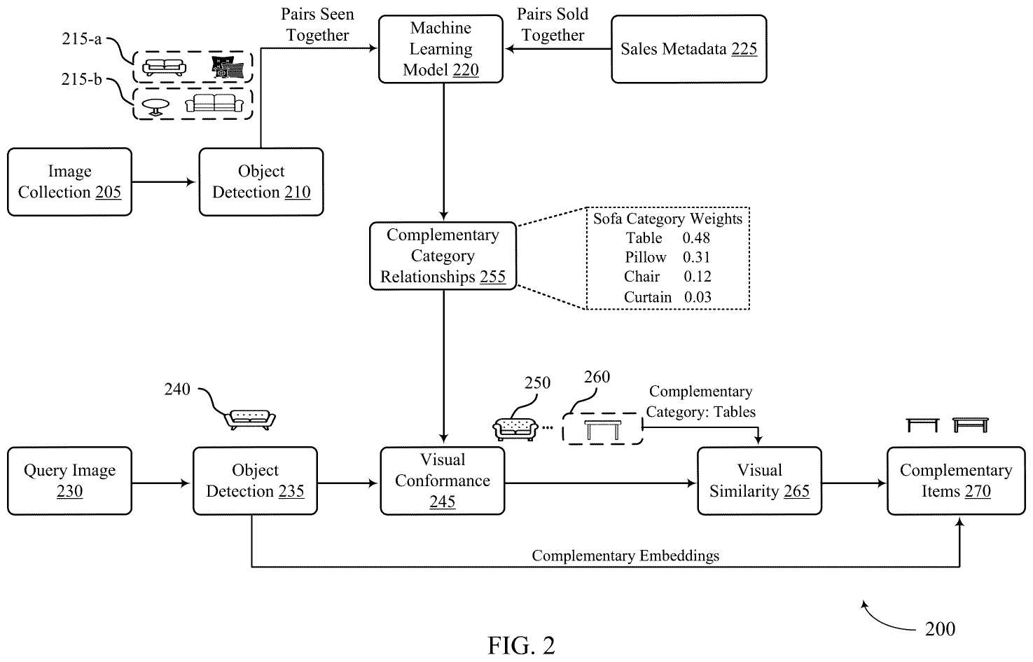

FIG. 2 shows an example of a flowchart 200 that supports data-driven automated visual conformance estimation for complementary item discovery in e-commerce in accordance with aspects of the present disclosure. Aspects of the flowchart 200 may implement, or be implemented by, aspects of the system 100 (e.g., aspects of the automated visual conformance system 145). In particular, the flowchart 200 illustrates steps and operations used to recommend complementary items based on visual similarity and conformance, as described previously herein.

In some aspects, the flowchart 200 illustrates example steps, operations, and functions which may be carried out by one or more components of the system 100, such as the automated visual conformance system 145. In this regard, the automated visual conformance system 145 illustrated in FIG. 2 may include, and/or may be configured to perform, the various steps and operations illustrated in FIG. 2.

Co-present items depicted within a same image may provide clues for visual conformance. As such, techniques described herein may be configured to quantize visual conformance (e.g., visual and/or stylistic conformance) on multi-item images using machine learning models and other image processing techniques. In some cases, complementary item recommendations based on visual conformance may include two primary operations, which are generally illustrated in the top and bottom halves of the flowchart 200.

As a first primary operation (or set of operations), as shown in the top half of the flowchart 200, and as will be further described herein, categorical relationships between different item/product categories may be defined. In this first primary operation, pairs of items within a same image(s) may be identified by an object detector. The pairs of items may be used to generate or compute a data object (e.g., two-dimensional (2D) graph) that resembles the relevancy of the respective categories based on the co-presence of the items of the respective categories in the analyzed images. With clustering, the data object/graph may be partitioned into groups or pairs of item/product categories that appear together within the images. In this regard, generated data objects/graphs may specify or include relevant “complementary categories” for queried items. Populating item pairs of relevant categories, representations may be learned (e.g., by processors, machine learning models, etc.) for quantizing visual conformance of items.

As a second primary operation (or set of operations), as shown in the bottom half of the flowchart 200, and as will be further described herein, the system (e.g., automated visual conformance system 145) may receive a query image of a query item, and perform visually-conforming complementary item retrieval for the query images/items. In particular, items within received query images may be identified or detected, and the relevant complementary categories may be identified using the generated data objects. Visual conformance of the query item may be performed to identify similar-looking items in a catalog of images of relevant categories. Subsequently, the items associated with relevant/complementary categories to the query item may be identified and returned as search results responsive to the received query image.

In this regard, a system (e.g., automated visual conformance system 145 configured to implement the flowchart 200 illustrated in FIG. 2 may be configured to learn visual conformance (e.g., learn what items/product categories exhibit visual conformance) by analyzing a collection of object image pairs seen together within multi-object images (e.g., instances where a same image depicts multiple objects/items together). As compared to some conventional techniques for identifying complementary items, the techniques described herein for retrieving complementary items based on visual conformance may require little to no supervision. Moreover, such techniques may be adaptable and tunable over time, scalable to large quantities of items and product categories, and applicable across a wide variety of product categories and/or for diverse styles.

By way of example, reference will now be made to the flowchart 200 illustrated in FIG. 2. At 205, a system (e.g., automated visual conformance system 145) may collect or acquire a set of images that will be analyzed for visual conformance. The automated visual conformance system 145 may be configured to retrieve images from relevant catalogs or webpages (e.g., fashion catalogs, home and garden magazines, etc.), social media platforms, and the like.

At 210, the automated visual conformance system 145 may perform object detection to identify items within the images collected at 205. For example, processors of a server may utilize one or more machine learning models to perform object detection in order to identify items within the analyzed images. The respective items identified within the images may be associated with (or belong to) respective item or product categories, such as product categories of an online marketplace, which may include different hierarchical categories for respective items or products (e.g., “clothing” category, “sunglasses” category, “skirts” category, “home and garden” category, “furniture” category, “coffee table” category, etc.).

In particular, the automated visual conformance system 145 may be configured to identify multiple items that are co-depicted together in a same image. For example, when analyzing an image of a bedroom, the automated visual conformance system 145 may be configured to identify a bed, a mattress, pillows, a side-table, a rug, curtains, etc., such that the items are considered “co-depicted” together within that same image. In some aspects, the automated visual conformance system 145 may be configured to utilize one or more machine learning models (e.g., machine learning classifiers, algorithms, etc.) or computer vision techniques that are configured to identify and classify items detected within the analyzed images. In general, the automated visual conformance system 145 may utilize any techniques known in the art to perform item detection and identification, including neural networks, deep learning, convolutional neural networks (CNNs), and the like. In some implementations, separate machine learning models may be trained to identify items of different categories (e.g., first model trained to identify fashion/apparel items, second model trained to identify furniture items, etc.).

In this regard, the automated visual conformance system 145 may be configured to identify groups or pairs of items that are frequently depicted together within the analyzed images (e.g., groups of co-depicted items 215). The automated visual conformance system 145 may process each image of an image set to determine which set of items are detected in an image, and may count, over the image set, a quantity of how often groups or pairs of items were depicted together within the set of analyzed images (e.g., a sofa and a pillow were depicted together withing a same image for fifteen images of the ninety images being analyzed). Stated differently, the automated visual conformance system 145 may be configured to “learn” or identify a relative frequency with which different types of items (and/or items of different categories) are pictured together within a same image. For example, as shown in FIG. 2, the automated visual conformance system 145 may be configured to identify a first pair of co-depicted items 215-a including sofas and pillows based on sofas and pillows frequently being depicted together within a same image for the set of analyzed images. Similarly, the automated visual conformance system 145 may be configured to identify a second pair of co-depicted items 215-b including coffee tables and sofas based on coffee tables and sofas frequently being depicted together within a same image of the set of analyzed images. In another example, in the set of analyzed images, there may be multiple instances in the image set where coffee tables and sofas are identified as being depicted together in a same image.

In additional or alternative implementations, the automated visual conformance system 145 may utilize generic object detection techniques to identify items/products within images. In such cases, when the system identifies items or objects with no category identification (e.g., the product category is unknown), the system may still be configured to generate or identify pairs of items/objects depicted together in images, and may be configured to train models for learning the visual conformance. When such a visual conformance model is trained, for any given pair or items/objects, the system may be configured to compute a score estimating visual conformance. However, in such cases where the system is unable to identify corresponding product categories of identified items, the system may not know or identify what product category the model is recommending.

At 220, a machine learning model may be trained (e.g., by the automated visual conformance system 145) to identify complementary category relationships between different product categories. In particular, the machine learning model may be configured to determine which groups or pairs of categories are related to one another (e.g., which categories are “complementary.” to one another) based on the relative frequencies that items of the respective product categories are co-depicted together within a single image of the set of analyzed images. In an example, the machine learning model may identify that in a set of images, fifteen of the images depict both a coffee table and a sofa in the same image.

For example, as shown in FIG. 2, the pairs of co-depicted items 215-a, 215-b may be inputted into a machine learning model (e.g., neural network, deep learning model, CNN), where the machine learning model is configured to identify complementary category relationships. For instance, the machine learning model may be configured to identify a first complementary category relationship between “sofas” and “pillows” based on sofas and pillows being frequently depicted together in the analyzed images (as illustrated by the first pair of co-depicted items 215-a). As such, the first complementary category relationship may indicate that “sofas” and “pillows” are complementary to one another, in that they are frequently shown/located close to one another in the same image, and it would be logical that users who purchase a sofa may also be interested in pillows.

Similarly, the machine learning model may be configured to identify a second complementary category relationship between “coffee tables” and “sofas” based on coffee tables and sofas being frequently depicted together in the analyzed images (as illustrated by the second pair of co-depicted items 215-b). As such, the second complementary category relationship may indicate that “sofas” and “coffee tables” are complementary to one another, in that they are frequently shown/located close to one another in a single image, and it would be logical that users who purchase a sofa may also be interested in coffee tables. In this regard, the automated visual conformance system 145 (e.g., machine learning model) may determine complementary category relationships between different product categories based on the relative frequency that items of the respective product categories are depicted together within the analyzed images.

In some cases, the system/machine learning model may be configured to normalize quantities of items identified within the images to generate complementary category relationships that more accurately represent groups/pairs of complementary items. In other words, the automated visual conformance system 145 may be configured to determine complementary category relationships based on the relative frequency that items are depicted together, rather than the total quantity of appearances or occurrences that different items are depicted in the images.

For example, the automated visual conformance system 145 may be configured to determine a quantity of appearances of different types of items or product categories within the set of analyzed images (e.g., how often “sofas” and “curtains” are depicted in the same image of the set of analyzed images), and may be configured to normalize absolute quantities of appearances of the different items/categories in order to determine relative frequencies that items/categories are depicted together. By normalizing absolute quantities of appearances of different items or categories, techniques described herein may more effectively identify pairs of related/complementary categories. For instance, if sofas are depicted in the images far more than any other type of item, relationships between sofas and other product categories may be weighted more heavily. As such, by normalizing the total quantity of sofas depicted in the images relative to quantities of appearances of other types of items, the automated visual conformance system 145 may instead be configured to determine complementary category relationships based on the relative frequency that sofas are depicted with other items, which may lead to more accurate identification of related/complementary categories.

In some aspects, at 220, the machine learning model may be configured to determine or assign scores to the respective complementary category relationships. Scores of the complementary category relationships may indicate relative strengths of relationships between the respective product categories. For example, a first complementary category relationship between “sofas” and “coffee tables” may be assigned a higher score as compared to a second complementary category relationship between “sofas” and “shovels” due to the fact that sofas are depicted (and sold) together with coffee tables more frequently as compared to shovels.

In some cases, the system/machine learning model may additionally be configured to determine complementary category relationships between item categories based on what types of items are frequently sold together. For example, at 225, sales metadata (e.g., purchasing history information) from an online marketplace may be retrieved by the automated visual conformance system 145 (e.g., from the data center 120) and inputted into the machine learning model, where the machine learning model is configured to determine complementary category relationships based on both (1) the sales metadata, and (2) the relative frequency that items of different categories are depicted within images together. For instance, the machine learning model may determine a first complementary category relationship between “sofas” and “pillows” based on sofas and pillows being frequently co-depicted together within a same image for a set of images, as well as sofas and pillows frequently being purchased together from the online marketplace using the sales metadata. The sales metadata 225 may also include other types of metadata, including a count of images views or listing views that includes one or more images that depict complementary items together in a same image.

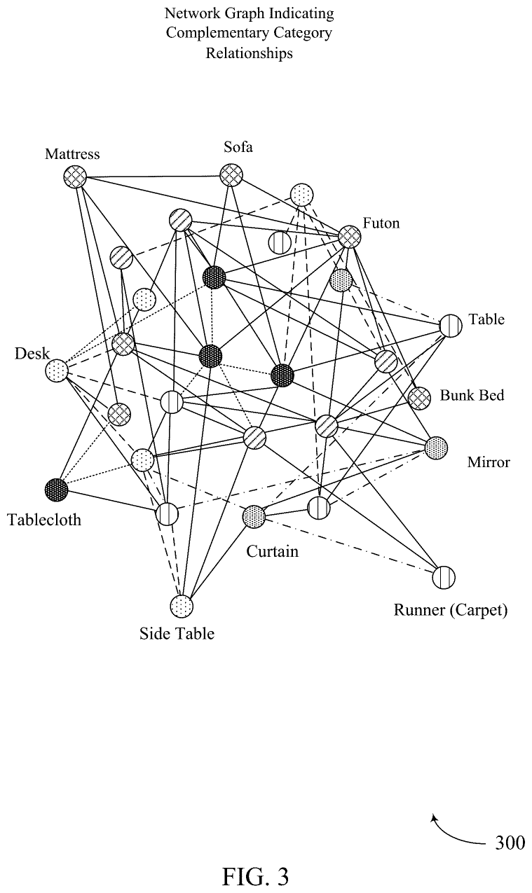

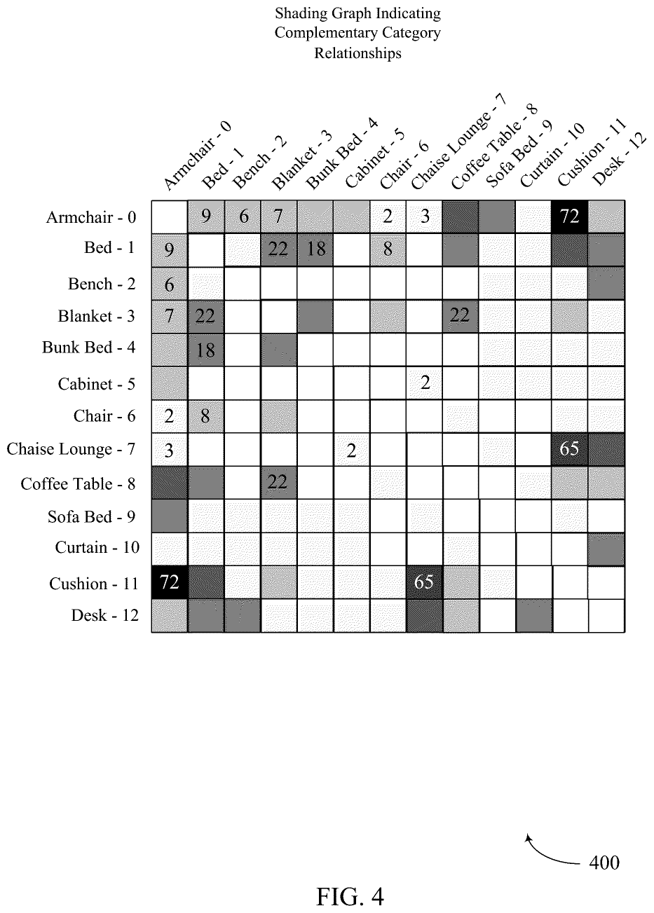

In some implementations, the automated visual conformance system 145 may be configured to generate one or more data objects that indicate or display complementary category relationships between respective groups/pairs of product categories (e.g., data objects that indicate relative frequencies with which items of different categories are co-depicted and/or purchased together). Data objects that depict or illustrate complementary category relationships may include network graphs, 2D shading graphs, and the like, and may be further shown and described with reference to FIGS. 3 and 4.

FIG. 3 shows an example of a data object 300 that supports data-driven automated visual conformance estimation for complementary item discovery in e-commerce in accordance with aspects of the present disclosure. Aspects of the data object 300 may implement, or be implemented by, aspects of the system 100, the flowchart 200, or both.

In particular, the data object 300 in FIG. 3 illustrates an example of a network graph that may be generated (e.g., by a machine learning model) to illustrate or depict complementary category relationships between respective product categories. As described in FIG. 2, an automated visual conformance system 145 may be configured to generate the data object 300 (e.g., network graph) based on a relative frequency that items of different product categories are co-depicted within images together, based on purchasing history information (e.g., sales metadata) indicating groups of items that are frequently sold together, or both.

The nodes of the data object 300 may illustrate or represent different product categories, such as product categories of an online marketplace. In some cases, product categories may be grouped into different sets of product categories, where nodes of the data object 300 with the same fill/shading may be included in the same group. In particular, the automated visual conformance system 145 may be configured to generate groups of related complementary category relationships (e.g., based on how often items of the categories in the groups are depicted/sold together).

For instance, an example grouping of product categories may include: blankets, bunk beds, chaise lounges, sofas, beds, futons, and mattresses. Other example groupings of product categories may include: (1) benches, chairs, desks, dining tables, stools, (2) armchairs, coffee tables, cushions, loveseats, sofas, (3) beds, headboards, pillows, tablecloths, (4) cabinets, dressers, runners (carpets), (4) lamps, lampshades, tables, curtains, mirrors, (5) paintings, artwork, statues. In some cases, the system may perform categorical grouping across product categories using a Louvain algorithm for partitioning across categories, a generic graph partitioning algorithm, and the like.

As shown in FIG. 3, the nodes of the data object 300 (which represent different product categories) may be connected to one another via one or more lines, where the lines indicate relationships between the respective nodes/categories. In this regard, the lines connecting the nodes in FIG. 3 may represent complementary category relationships between the product categories represented by the respective nodes.

In some cases, the automated visual conformance system 145 (e.g., machine learning model) may be configured to generate the data object 300 such that properties of the respective lines indicate relative strengths of relationships between the respective product categories. In other words, properties of the line(s) (e.g., line thickness, quantity of lines between nodes, dash type) between a pair of product categories may indicate, or be associated with, the score of the complementary category relationship between the respective product categories.

For example, product categories with larger quantities of lines (and/or thicker lines, or lines with different dash patterns) may illustrate categories that are more closely related with one another (and may therefore illustrate a complementary category relationship with a higher score). Conversely, product categories with fewer (or no) lines between them (and/or thinner lines, or lines with other dash patterns) may illustrate categories that are less closely related with one another (and may therefore illustrate a complementary category relationship with a lower score).

It is noted that the relationships indicated by the data object 300 may be updated over time based on a relative frequency that items of different product categories are co-depicted within images together, based on purchasing history information (e.g., sales metadata) indicating groups of items that are frequently sold together, or both. Over time, the machine learning model 220 may receive one or more new images (e.g., update a relative frequency that items of different product categories are co-depicted within images together based on the one or more new images), new sales metadata 225, or both, for updating the complementary category relationships depicted in the data object 300.

FIG. 4 shows an example of a data object 400 that supports data-driven automated visual conformance estimation for complementary item discovery in e-commerce in accordance with aspects of the present disclosure. Aspects of the data object 400 may implement, or be implemented by, aspects of the system 100, the flowchart 200, the data object 300, or any combination thereof. For example, the data object 400 may include an additional or alternative depiction of identified complementary category relationships as was shown and described in the data object 300 of FIG. 3. In this regard, in some cases, the data object 300 and the data object 400 are examples of two different ways of illustrating identified complementary category relationships between items seen/sold together.

The data object 400 in FIG. 4 illustrates an example of a 2D shading graph that may be generated (e.g., by a machine learning model) to illustrate or depict complementary category relationships between respective product categories. In some cases, the automated visual conformance system 145 may generate a 2D matrix describing complementary category relationships, and may partition the 2D matrix to generate the graph shown in the data object 400. As described in FIG. 2, a system (e.g., automated visual conformance system 145) may be configured to generate the data object 400 (e.g., 2D shading graph) based on a relative frequency that items of different product categories are co-depicted within images together, based on purchasing history information (e.g., sales metadata) indicating groups of items that are frequently sold together, or both.

The data object 400 illustrates different combinations of product categories, as indicated on the X and Y-axes of the data object 400. The shaded blocks at the intersections of the respective pairs of product categories may indicate how related (e.g., how complementary) the respective pairs of product categories are, where darker blocks indicate pairs of product categories that are more related/complementary to one another, and lighter blocks indicate pairs of product categories that are less related/complementary to one another. In this regard, darker blocks may indicate higher scores of complementary category relationships between respective pairs of categories, where lighter blocks may indicate lower scores of complementary category relationships between respective pairs of product categories.

Moreover, the respective shaded blocks may include numbers, as shown in FIG. 4. It is noted herein that only a subset of the shaded blocks are depicted with numbers for the purposes of simplicity. In some aspects, the numbers within the shaded blocks may further indicate how related (e.g., how complementary) the respective pairs of product categories are, where larger numbers indicate pairs of product categories that are more related/complementary to one another, and smaller numbers indicate pairs of product categories that are less related/complementary to one another. In this regard, the numbers may include, or may be representative of, relative “scores” between pairs of product categories, where the scores indicate how related/complementary the respective product categories are to one another.

As such, larger numbers may generally be associated with darker shaded blocks, where smaller numbers may be generally associated with lighter shaded blocks. In some cases, the automated visual conformance system 145 may generate the numbers/scores between respective pairs of product categories, and may generate the shading for the respective blocks based on the determined number/score (e.g., the shading for the blocks at the intersection of “bed” and “armchair” may be based on the determined number/score of “9”).

In some aspects, the depicted numbers within the shaded blocks may be normalized on a scale from 0 to 100. In particular, the depicted numbers may be normalized, as described herein based on a relative frequency that items/products of the different product categories are depicted together within images of the set of images analyzed by the automated visual conformance system 145. For example, in some cases, the automated visual conformance system 145 may determine a quantity of appearances/occurrences that items of the respective categories are depicted in the images, and normalize the total quantities of appearances/occurrences across the categories. In this regard, in cases where the relative colors/shadings are determined based on the determined numbers/scores, the respective colors/shadings may therefore be normalized on a scale between 0 and 100 based on the relative frequency that items of the respective pairs of product categories are depicted within images together (and/or relative frequency that items of the respective pairs of product categories are sold together).

For example, blocks at the intersection of “blanket” and “armchair” are denoted with a number/score of “7” and are therefore depicted as a light color, indicating a relatively low score of a complementary category relationship between “blankets” and “armchairs” due to the fact that blankets and armchairs are depicted and/or sold together with a relatively low frequency (e.g., approximately 7% of images depicting a blanket also depict an armchair, or vice versa). Comparatively, blocks at the intersection of “blankets” and “beds” are denoted with a number/score of “22” and are therefore depicted as a darker color, indicating a relatively high score of a complementary category relationship between “blankets” and “beds” due to the fact that blankets and beds are depicted and/or sold together with a relatively high frequency (e.g., approximately 22% of images depicting a blanket also depict a bed, or vice versa). In this regard, by comparing the numbers/scores (and/or colors/shadings) between “blankets/armchairs” and “blankets/beds,” it may be seen that “blankets” are more related/complementary to “beds” as compared “armchairs” due to the blocks at the intersections of “blankets/beds” depicting a higher number (and darker color) as compared to blocks at the intersections of “blankets/armchairs.”

Reference will again be made to the flowchart 200 illustrated in FIG. 2. At 230, the system (e.g., automated visual conformance system 145) may receive a query image from a user (e.g., client device 110), where the query image depicts one or more query items (e.g., query item 240). At 235, the automated visual conformance system 145 may perform object detection, as shown and described with respect to step 210 of the flowchart 200. In this regard, the automated visual conformance system 145 may utilize one or more machine learning models (such as the machine learning model used in step 210, including neural networks, CNNs, etc.) to identify and classify the query item 240 depicted in the query image.

For instance, as shown in FIG. 2, a user may submit a query image that depicts a sofa (query item 240) in order to find complementary items for the sofa. In this example, the automated visual conformance system 145 may identify the query item 240 within the query image, and identify that the query item 240 belongs to the product category “sofa” of the online marketplace.

At 245, the automated visual conformance system 145 may perform visual conformance to identify other items that are visually similar to the query item 240. In other words, the automated visual conformance system 145 may identify other sofas depicted within the images analyzed at 205 (and/or other sofas sold on the online marketplace) that are visually similar to the sofa (query item 240) depicted in the query image. For example, as shown in FIG. 2, the automated visual conformance system 145 may identify another sofa (visually-similar item 250) that is visually similar to the sofa (query item 240) depicted in the query image.

When evaluating items that are “visually similar” to the query item 240, the automated visual conformance system 145 may analyze a set of visual similarity criteria, including a color criterion, a stylistic criterion, a texture criterion, and the like. In this regard, the visually-similar item 250 that is identified as being visually similar to the sofa (query item 240) from the query image may exhibit the same or similar color, style, texture, pattern, size, shape, and/or fabric as the sofa from the query image. In this regard, visual similarity may be evaluated by comparing one or more attributes. In additional or alternative implementations, visual similarity may be determined or assessed with a trained model. That is, a model for assessing visual similarity may be trained on a set of images where similar items are grouped in different categories, where the model is trained to learn the feature vectors for categorization. Using these feature vectors, the model may be configured to compute a score which values the similarity of a pair of items, where pairs of items with high scores indicate pairs of items that are highly visual similar (or identical) to one another, and where pairs of items with low scores indicate pairs of items that are not visually similar to one another.

In some aspects, embedding generation may be performed with feature vectors (e.g., 2048-dimensional visual embeddings), dimensionality reduction (e.g., 200-dimensional with PCA), distances between images of items (e.g., cosine (default) and Euclidean), Facebook AI Similar Search (FAISS) for k-nearest neighbor (k-NN) searches, and the like. Further, after retrieving the complementary items 260 to the user, the system may perform post-processing operations, such as performing deduplication (e.g., removal of duplicate copies of similar complementary items) using a perceptual hash. In some cases, the system may be configured to perform deduplication after retrieving complementary items since some product listings on an online marketplace (or other database of images) may include identical items. By removing the duplicates, the suggested complementary items become more diverse and inclusive.

For example, after identifying an item/product within an image, the automated visual conformance system 145 may examine 2048 dimensions of visual feature attributes to generate a feature vector for the item/product that includes 2048 values or dimensions. In some cases, the automated visual conformance system 145 may then select 200 of the 2048 that best represent the data or which carry the most information, and then compare the 200 values/dimensions with values/dimensions of other feature vectors associated with other items/products to determine a distance metric (e.g., Euclidian distance) between the feature vectors, where the distance metric is used to determine a level of visual similarity/conformance between the respective items/products. For example, if one of the dimensions is always the same even if the dimension has the highest value, the dimension may be said not to be representative of the data (and may therefore not be selected as one of the 200 selected dimensions), whereas another dimension with a low value may still be very representative of the data (and may therefore be selected as one of the 200 selected dimensions).

In some cases, dimensionality reduction (e.g., selecting 200 of the 2048 values/dimensions) may be performed to speed up the retrieval process for complementary items (e.g., rather than comparing 2048 values, the system may compare 200 values for assessing the similarity of two items to expedite results retrieval). As such, in some implementations, dimensionality reduction may not be performed.

At 255, the automated visual conformance system 145 may identify complementary category relationships that are relevant to the query item(s) 240 depicted in the query image in order to identify other product categories that are complementary to the product category of the query item(s) 240. In other words, the automated visual conformance system 145 may identify complementary category relationships for “sofas” to determine other product categories that are complementary to sofas. For instance, as shown in FIG. 2, the system may identify that “tables,” “pillows,” “chairs,” and “curtains” are complementary product categories to sofas (e.g., based on determined complementary category relationships between “sofas” and “tables,” between “sofas” and “pillows,” etc.).

In some aspects, the automated visual conformance system 145 may be configured to identify relevant complementary category relationships associated with the product category of the query item 240 by referencing the one or more data objects generated at 220. In other words, the automated visual conformance system 145 may identify other product categories that are associated with (e.g., complementary to) “sofas” by referencing the data objects 300, 400, as illustrated in FIGS. 3 and 4, respectively.

In cases where the query image includes multiple items of different categories, the automated visual conformance system 145 may be configured to identify complementary category relationships that are associated with all (or at least a subset) of items/categories within the query image. In other words, for query images that include multiple items, the automated visual conformance system 145 may be configured to evaluate complementary category relationship of all the items in order to identify items that will be complementary to all the items depicted in the query image. As a specific use case, a user may submit an image of their bedroom with a bed, nightstands, and rug, with a request for the system to “complete the room” by finding items of other categories (e.g., curtains, decorations, etc.) that will complement the depicted bed, nightstands, and rug.

In some cases, as described previously herein, the automated visual conformance system 145 may be configured to rank the relevant complementary category relationships according to scores corresponding to the complementary category relationships. In some cases, higher scores may indicate stronger complementary category relationships (e.g., categories that are more related or complementary to one another), whereas lower scores may indicate weaker complementary category relationships (e.g., categories that are less related or complementary to one another). For example, as shown in FIG. 2, a first complementary category relationship between “sofas” and “tables” may be associated with a score of 0.48, whereas a second complementary category relationship between “sofas” and “pillows” may be associated with a score of 0.31. In some aspects, the scores for the pairs/groups of complementary category relationships (e.g., the scores 0.48, 0.31, etc.) may be normalized to some values (e.g., based on 300 or 400, the system normalizes the scores between 0) and 1, and then sorts the scores from high to low). In this example, the automated visual conformance system 145 may have determined that tables are co-depicted (and/or purchased) together with sofas more frequently as compared to pillows, and are therefore more complementary to sofas as compared to pillows.

In some cases, the automated visual conformance system 145 may be configured to return complementary items of other product categories that exhibit the highest score(s). For example, in cases where the user submits a query image of the sofa (query item 240), the automated visual conformance system 145 may be configured to return images/product listings of tables due to the fact that the complementary category relationship between “sofas” and “tables” exhibits the highest score. In other cases, the automated visual conformance system 145 may be configured to return images/product listings of items belonging to product categories with the X highest scores (e.g., return product listings of tables, pillows, and chairs for the three most-complementary categories). In such cases, search results returned to the user may include complementary items of multiple categories, where the complementary items may be ordered or organized based on the respective scores (e.g., in descending order of appliable scores, where tables are provided or viewed first, followed by pillows, then chairs, etc.).

In additional or alternative cases, the user may be able to input or request what types of product categories the user is looking for. For example, in cases where the user submits the image of the sofa (query item 240), the user may request that the automated visual conformance system 145 return product listings of curtains that will match/complement the sofa. In this example, the automated visual conformance system 145 may be configured to return product listings of curtains despite the fact that curtains are less complementary to sofas as compared to tables, pillows, etc.

Once the automated visual conformance system 145 identifies what product category/categories are complementary to the query item 240, and therefore what items/product listings will be recommended to the user as complementary items, the flowchart 200 may proceed to step 265.

At 265, the automated visual conformance system 145 may identify complementary items 260 of the complementary product categories that are depicted with (or are visually similar to) the visually-similar items 250 that are visually similar to the query item 240.

For example, as described previously herein, the system may identify other sofas (visually-similar items 250) that are visually similar to the sofa (query item 240) from the query image. In this example, and in cases where the automated visual conformance system 145 is configured to identify tables that are complementary to the sofa from the query image, the system may identify other tables (complementary items 260) that are depicted with (and/or sold together with) the visually-similar items 250. That is, once the automated visual conformance system 145 has found other sofas that are visually similar to the sofa from the query image, the automated visual conformance system 145 may identify tables that are depicted together with the visually similar sofas (or identify tables that are visually similar to the tables depicted together with the visually similar sofas). In this regard, the automated visual conformance system 145 may be configured to identify tables (e.g., complementary items 260) that are more likely to visually and stylistically complement the sofa (query item 240) from the query image.

In some cases, the automated visual conformance system 145 may be configured to take the user's preferences into account when retrieving complementary items. User preferences may include preferences for certain styles, colors, fabrics, textures, and the like, and may be retrieved from a number of sources, including preferences explicitly indicated by the user, prior purchasing history of the user, etc. For example, some users may prefer a very neutral color palette, such that the automated visual conformance system 145 is configured to identify and return mostly (or exclusively) complementary items that fit the neutral color palette. Comparatively, other users may have an affinity to funky textures or patterns. In such cases, the automated visual conformance system 145 may be configured to identify complementary items with funky textures/patterns that are depicted with the visually-similar items 250. For instance, if the system is configured to return images/listings of throw pillows to complement the queried sofa, the system will find funky throw pillows that are depicted with sofas that are visually similar to the sofa from the query image.

As noted previously herein, when determining visual similarity between items, the automated visual conformance system 145 may generate a feature vector (e.g., 2048 dimensional feature vector) for respective items/products, and compare feature vectors between items/products to generate some distance metric (e.g., Euclidian distance) between the feature vectors, where the distance metric indicates a relative degree of visual similarity between the respective items/products.

At 270, the automated visual conformance system 145 may transmit, to the client device 110 in response to the received query image, a search result that indicates the complementary items 260 (or items that are visually similar to the complementary items 260). In other words, upon identifying other tables that are visually and stylistically complementary to the sofa from the query image, the automated visual conformance system 145 may return a search result that includes images of the complementary tables, and/or product listings that list the complementary tables for sale via the online marketplace.

In some cases, the automated visual conformance system 145 may be configured to further train the machine learning model to identify complementary items by associating the query item 240 and the complementary items 260 as “complementary embeddings.” In other words, the system may associate the sofa from the query image with the tables returned as a search result as being complementary to one another, and may input the associated sofa and complementary tables back into the machine learning model to further train the machine learning model to recognize complementary items. In this regard, as the automated visual conformance system 145 performs more searches and retrieves more search results for complementary items (and as users purchase or otherwise interact with recommended complementary items), the machine learning model may become more and more effective and efficient at identifying complementary items. Thus, returned complementary items (and user interactions selecting or purchasing the recommended complementary items) may be used as additional inputs to further train machine learning models to retrieve complementary items across a wide range of product categories.

In some aspects, the process shown and described in FIG. 2 may be repeated based on user actions. In particular, the automated visual conformance system 145 may be configured to iteratively provide complementary items 260 as the user continues to browse the online marketplace and interact with items/product listings. For example, continuing with the same example, the automated visual conformance system 145 may provide the search result that indicates the complementary items 260 (complementary tables) in response to the query image depicting the sofa. In this example, the user may purchase, view, select, or otherwise interact with one of the tables (complementary items 260) returned to the user. In this example, the table selected or purchased by the user may be used as a new “query item” to repeat the process illustrated in the flowchart 200.

In other words, the system (e.g., automated visual conformance system 145) may be configured to use the selected table to identify visually-similar tables (step 245), identify complementary product categories for the table (step 255), identify items of other product categories that are complementary to the visually-similar tables (step 265) and return another search result that includes recommended items that are complementary to the table. In such cases, the user may start with an image of the sofa, receive a search result with tables, select one of the received tables, and receive another search result with chairs that are complementary to the selected table. Such techniques may also be implemented in an “endless scrolling” implementation, where a user scrolling through items/product listings of an online marketplace results in traversal among specific object categories based on relativity. In other words, the user may start searching for tables, where continued scrolling returns results for chairs (as complementary items to tables), then returns results for slip covers (as complementary items to chairs), then returns results for table decorations (as complementary items to slip covers), etc.

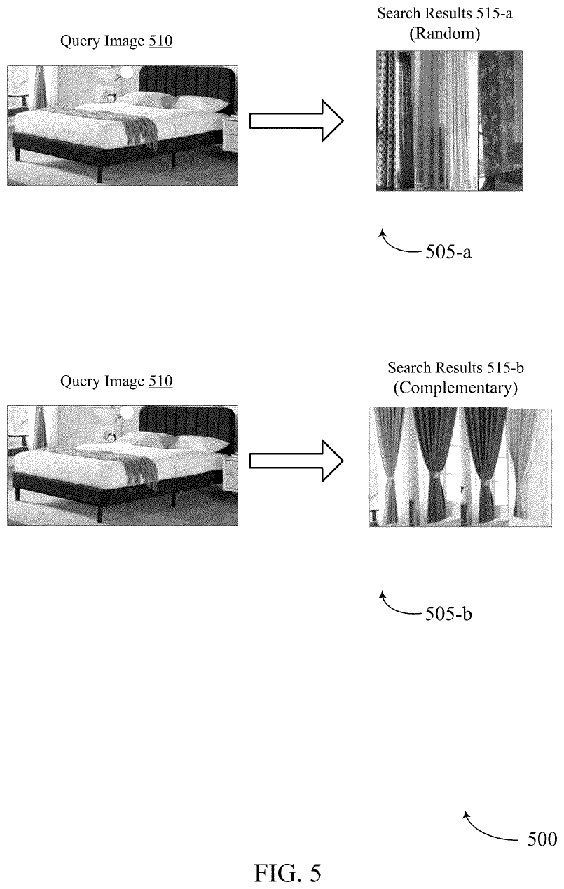

Attendant advantages of the techniques used to return complementary items using visual conformance may be further shown and described with reference to FIG. 5.

FIG. 5 shows an example of an item recommendation diagram 500 that supports data-driven automated visual conformance estimation for complementary item discovery in e-commerce in accordance with aspects of the present disclosure. Aspects of the item recommendation diagram 500 may implement, or be implemented by, aspects of the system 100, the flowchart 200, the data objects 300, 400, or any combination thereof.

The item recommendation diagram 500 illustrates different examples where a user submits a query image 510 of a bed (shown on the left side), and a system (e.g., automated visual conformance system 145) returns or recommends curtains that are complementary to the bed depicted in the query image 510. In this regard, the bed depicted in the query image 510 may be another example of the query item 240 in FIG. 2, where the curtains depicted in the search results 515 may be examples of the complementary items 260 that are returned to the user in FIG. 2.

The top row 505-a of the item recommendation diagram 500 illustrates an example of a search query and result where a system return complementary items based on conventional techniques. In particular, the top row 505-a illustrates previous techniques that retrieve complementary items based on purchasing history and/or item titles or descriptions. As may be seen in the top row 505-a, the recommended “complementary” curtains returned in the search results 515-a may not aesthetically or stylistically match or complement the modern-looking bed depicted in the query image 510 on the left. In other words, a user that submits the query image 510 of the modern-looking bed is unlikely to purchase bright, floral-printed curtains returned in the search results 515-a to the right.

Comparatively, the bottom row 505-b illustrates techniques of the present disclosure that recommend complementary products based on visually similar products that are frequently depicted in images together. In this regard, the bottom row 505-b illustrates an example search query and result that may be performed by the automated visual conformance system 145 according to techniques described herein.

As described with reference to FIG. 2, upon receiving the query image 510, the system (e.g., automated visual conformance system 145) may be configured to identify visually-similar beds, identify curtains that are depicted within images together with the visually-similar beds, and return the identified curtains (or other visually-similar curtains) to the use via the search results 515-b. By comparing the top row 505-a and the bottom row 505-b, it may be seen that techniques described herein (as shown in the bottom row 505-b) return recommendations of curtains that more aesthetically and stylistically match the modern bed depicted in the query image 510.

As such, techniques described herein may improve a quality of item recommendations provided to users, and may increase a level of engagement (e.g., increase purchases) for the returned complementary items. Thus, the complementary item recommendation techniques described herein may be used to find the best matching items to a group of query items (e.g., return complementary items to “complete the room” based on query items in the room), and/or find visually complementary items to a query item (e.g., find matching items).

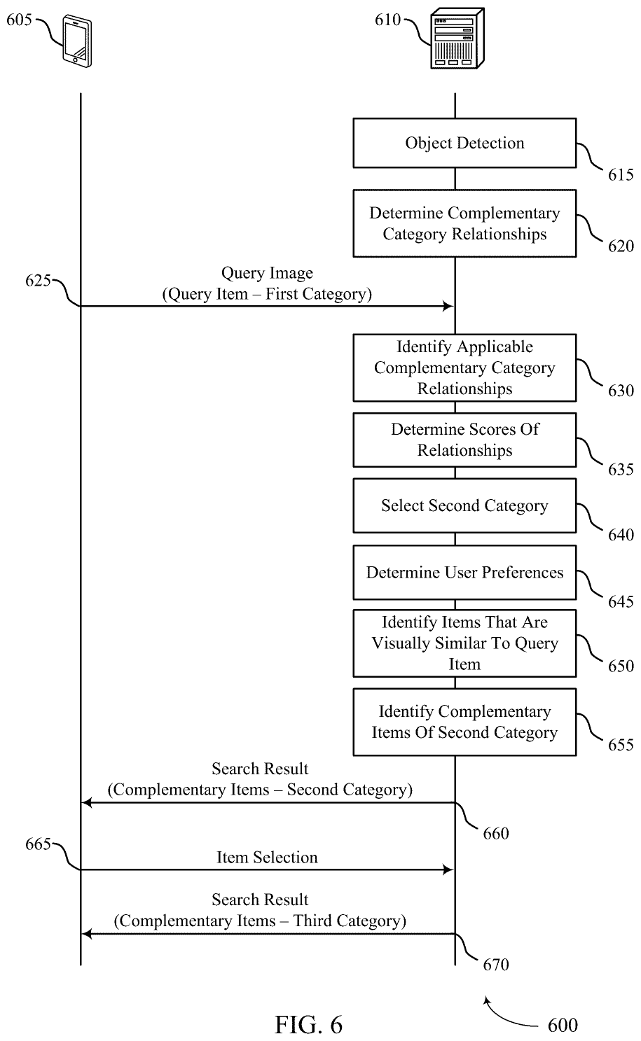

FIG. 6 shows an example of a process flow 600 that supports data-driven automated visual conformance estimation for complementary item discovery in e-commerce in accordance with aspects of the present disclosure. Aspects of the process flow 600 may implement, or be implemented by, aspects of the system 100, the flowchart 200, the data objects 300, 400, the item recommendation diagram 500, or any combination thereof.

The process flow 600 may include a client device 605 and a server device 610, which may be examples of other devices described herein with reference to FIGS. 1-5. For example, the client device 605 may be an example of a client device 110 illustrated in FIG. 2, and the server device 610 may be an example of the automated visual conformance system 145, the cloud clients 105, the subsystem 125, the cloud platform 115, or any combination thereof, as illustrated in FIG. 2.

In some examples, the operations illustrated in process flow 600 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

At 615, the server device 610 may perform object detection to identify items depicted within a set of images. For example, as shown in steps 205 and 210 of FIG. 2, the server device 610 may receive a set of images (e.g., from webpages, social media platforms, etc.) and identify items and corresponding product categories depicted together within the same images of the set images. As described previously herein, the server device 610 may be configured to utilize one or more machine learning models (e.g., neural network, CNN, etc.) to perform object detection and identification/classification.

At 620, the server device 610 may identify complementary category relationships between respective groups/pairs of product categories. In particular, the server device 610 may identify the complementary category relationships between respective categories based on performing the object detection/classification at 605. For example, as shown step 220 of FIG. 2, the server device 610 may utilize one or more machine learning models to identify complementary category relationships between product categories based on (1) a relative frequency that items of respective product categories are depicted together within the analyzed images, and/or (2) a relative frequency that items of the respective product categories are sold together via an online marketplace.

As noted previously herein, the server device 610 may be configured to determine how many times items of respective product categories are depicted within the images, and normalize the absolute quantities of appearances in order to determine the relative frequency that items of respective product categories are co-depicted with one another. In some aspects, the server device 610 may be configured to generate data objects (e.g., data objects 300 and 400 illustrated in FIGS. 3 and 4, respectively) that indicate or represent the determined complementary category relationships between respective groups or pairs of product categories.

At 625, the server device 610 may receive a query image from the client device 605, where the query image depicts one or more query items. For example, as shown in step 230 of FIG. 2, the server device 610 may receive a query image of a sofa. In this example, the server device 610 may be configured to identify and return items of other product categories that are associated with (e.g., match, or are complementary to) the sofa from the query image.

At 630, the server device 610 may identify complementary category relationships that are relevant or applicable to the one or more items from the query image. For example, as shown in step 255 of FIG. 2, the server device 610 may determine identify complementary category relationships between sofas and (1) tables, (2) pillows, (3) chairs, and (4) curtains. In this regard, the server device 610 may identify tables, pillows, chairs, and curtains as being “complementary items” to the sofa from the query image.

In some cases, the server device 610 may identify applicable complementary category relationships (and therefore complementary categories/items) by referencing the data objects generated by the server device 610 (e.g., by referencing the data objects 300, 400 illustrated in FIGS. 3 and 4).

At 635, the server device 610 may determine scores of the identified complementary category relationships. For example, as shown in step 255 of FIG. 2, the server device 610 may determine that a first complementary category relationship between “sofas” and “tables” has a score of 0.48, whereas a second complementary category relationship between “sofas” and “pillows” may be associated with a score of 0.31. In this example, the server device 610 may determine that tables are co-depicted (and/or purchased) together with sofas more frequently as compared to pillows, and are therefore more complementary to sofas as compared to pillows. In some cases, the server device 610 may determine or calculate the scores associated with the complementary category relationships by referencing the previously-generated data objects (e.g., data objects 300, 400 illustrated in FIGS. 3 and 4).

At 640, the server device 610 may select one or more other categories (e.g., a second category) that are complementary to the item(s) in the query image which will be returned as complementary items to the user. In some cases, the system may be configured to return complementary items of other product categories that exhibit the highest score(s). For example, in cases where the user submits a query image of the sofa (query item 240), the system may be configured to return images/product listings of tables due to the fact that the complementary category relationship between “sofas” and “tables” exhibits the highest score. In other cases, the system may be configured to return images/product listings of items belonging to product categories with the X highest scores (e.g., return product listings of tables, pillows, and chairs for the three most-complementary categories).

For the purposes simplicity and illustration, the server device 610 may determine that items associated with a second product category (e.g., tables) are to be returned to the user in the process flow 600. However, as described herein, in other cases, the server device 610 may select multiple product categories that are to be returned to the user as search results for complementary items.

At 645, the server device 610 may identify one or more user preferences of a user associated with the client device 605. In some cases, the user preferences may be retrieved from a user profile associated with the user on the online marketplace, determined based on prior purchase history of the user, and the like. As described previously herein, the server device 610 may be configured to take the user's preferences into account when retrieving complementary items. User preferences may include preferences for certain styles, colors, fabrics, textures, and the like, and may be retrieved from a number of sources, including preferences explicitly indicated by the user, prior purchasing history of the user, etc.

At 650, the server device 610 may identify a first set of items that are visually similar to the query item(s) from the query image. For example, as shown in step 245 of FIG. 2, if the server device 610 receives a query image of a sofa, the server device 610 may identify other sofas within the analyzed images that are visually similar to the sofa from the query image. When evaluating items that are “visually similar” to the query item, the server device 610 may analyze a set of visual similarity criteria, including a color criteria, a stylistic criteria, a texture criteria, and the like.

At 655, the server device 610 may identify a second set of items (e.g., set of complementary items) of the second product category. In particular, the server device 610 may identify items of the second product category that are depicted with the first set of items that are visually similar to the query item (and/or items that are visually similar to items that are depicted with the first set of visually similar items). For example, as shown in step 265 of FIG. 2, after identifying other sofas that are visually similar to the sofa from the query image (e.g., visually-similar items 250), the server device 610 may be configured to identify tables that are depicted with the visually-similar sofas (or tables that are visually similar to the tables depicted with the visually-similar sofas).

At 660, the server device 610 may transmit a search result to the client device 605, where the search result includes complementary items of the second product category that are complementary to the query item(s) from the query image received at 625. In particular, the search result may include items of the second product category which were identified at 655. For example, as shown in step 270 of FIG. 2, the server device 610 may return a search result that includes complementary tables (e.g., complementary items 260) that are complementary to the sofa depicted in the query image.

At 665, the server device 610 may receive, from the client device 605, a selection of an item or product listing included within the search result provided at 660. For example, the user may select, view, purchase, or otherwise interact with a complementary table provided via the search result.

At 670, the server device 610 may return an additional search result that includes images or product listings of items associated with a third product category that are complementary to the item selected 665. In some cases, the server device 610 may be configured to utilize the item selection at 665 as a new “query image/input” to repeat the steps shown and described in FIG. 6 in order to return the second search result including complementary items of the third product category.

For example, continuing with the same example, the server device 610 may provide the first search result at 660 that indicates the complementary tables in response to the query image depicting the sofa. In this example, the user may purchase, view, select, or otherwise interact with one of the tables returned to the user at 665. In this example, the table selected or purchased by the user at 665 may be used as a new “query item” to repeat the process illustrated in the process flow 600. In other words, the server device 610 may be configured to use the selected table to identify complementary product categories for the table (step 630), identify visually-similar tables (step 650), identify items of other product categories that are complementary to the visually-similar tables (step 655) and return another search result that includes recommended items that are complementary to the table (step 670).

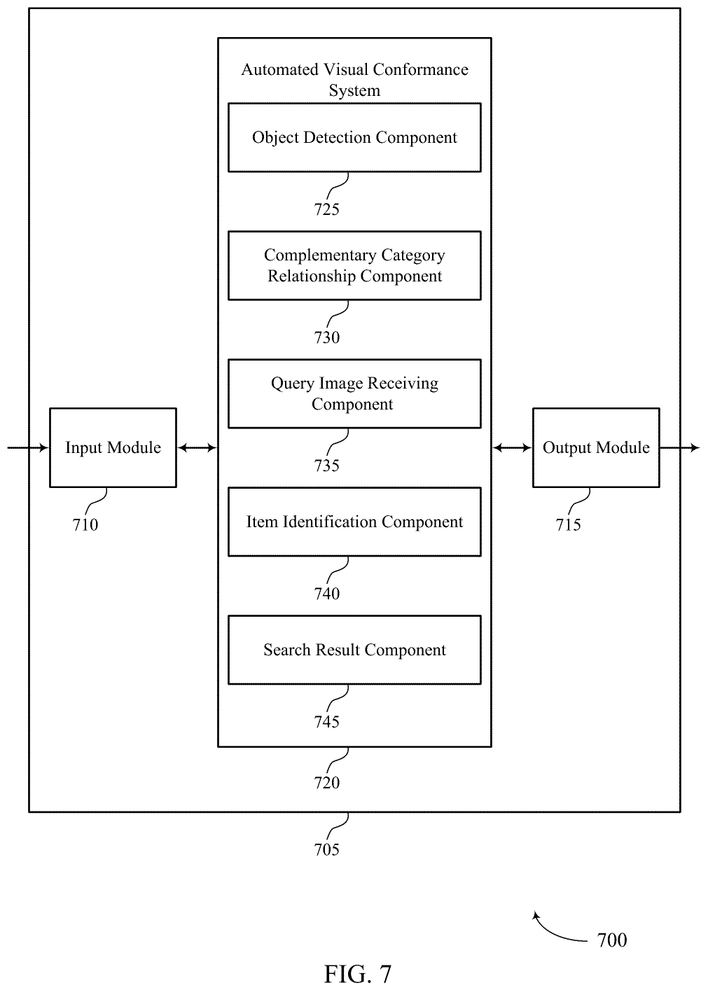

FIG. 7 shows a block diagram 700 of a device 705 that supports data-driven automated visual conformance estimation for complementary item discovery in e-commerce in accordance with aspects of the present disclosure. The device 705 may include an input module 710, an output module 715, and an automated visual conformance system 720. In some aspects, the automated visual conformance system 720 illustrated in FIG. 7 may be an example of the automated visual conformance system 145 illustrated in FIG. 1. The device 705 may also include a processor. Each of these components may be in communication with one another (e.g., via one or more buses).

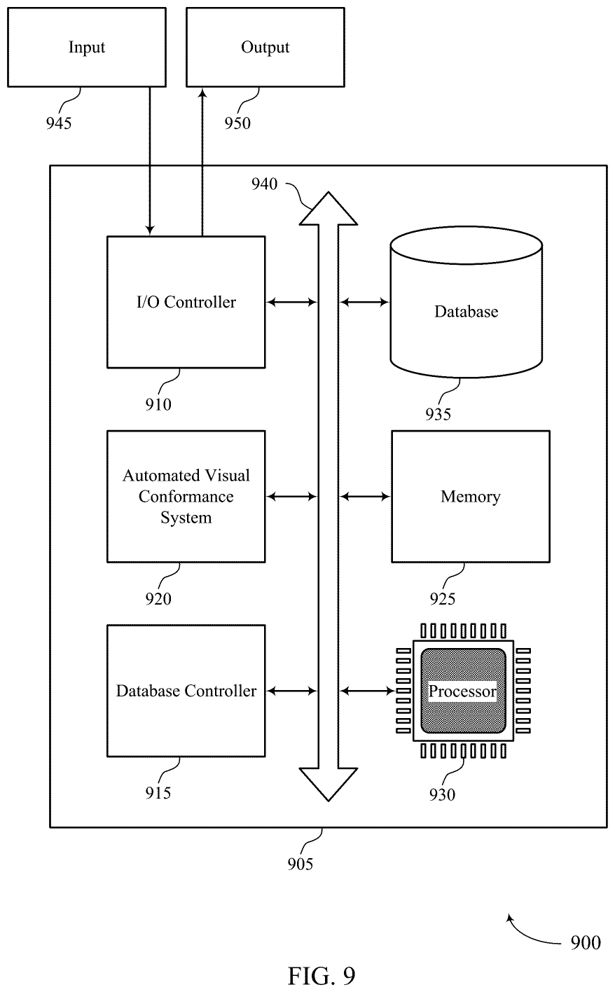

The input module 710 may manage input signals for the device 705. For example, the input module 710 may identify input signals based on an interaction with a modem, a key board, a mouse, a touchscreen, or a similar device. These input signals may be associated with user input or processing at other components or devices. In some cases, the input module 710 may utilize an operating system such as iOS R, ANDROIDR, MS-DOSR, MS-WINDOWSR, OS/2R, UNIXR, LINUXR, or another known operating system to handle input signals. The input module 710 may send aspects of these input signals to other components of the device 705 for processing. For example, the input module 710 may transmit input signals to the automated visual conformance system 720 to support data-driven automated visual conformance estimation for complementary item discovery in e-commerce. In some cases, the input module 710 may be a component of an I/O controller 910 as described with reference to FIG. 9.

The output module 715 may manage output signals for the device 705. For example, the output module 715 may receive signals from other components of the device 705, such as the automated visual conformance system 720, and may transmit these signals to other components or devices. In some examples, the output module 715 may transmit output signals for display in a user interface, for storage in a database or data store, for further processing at a server or server cluster, or for any other processes at any number of devices or systems. In some cases, the output module 715 may be a component of an I/O controller 910 as described with reference to FIG. 9.

For example, the automated visual conformance system 720 may include an object detection component 725, a complementary category relationship component 730, a query image receiving component 735, an item identification component 740, a search result component 745, or any combination thereof. In some examples, the automated visual conformance system 720, or various components thereof, may be configured to perform various operations (e.g., receiving, monitoring, transmitting) using or otherwise in cooperation with the input module 710, the output module 715, or both. For example, the automated visual conformance system 720 may receive information from the input module 710, send information to the output module 715, or be integrated in combination with the input module 710, the output module 715, or both to receive information, transmit information, or perform various other operations as described herein.

The object detection component 725 may be configured to support identifying, using one or more processors, a set of multiple items depicted within a set of multiple images, where the set of multiple items are associated with a first product category and a second product category of a set of multiple product categories of an online marketplace. The complementary category relationship component 730 may be configured to support determining, using the one or more processors, a complementary category relationship between the first product category and the second product category based on a relative frequency that items associated with the first product category and the second product category are depicted together within the set of multiple images. The query image receiving component 735 may be configured to support receiving, from a client device, a query image depicting a query item associated with the first product category of the set of multiple product categories. The complementary category relationship component 730 may be configured to support identifying that the first product category is complementary to the second product category of the set of multiple product categories based on the complementary category relationship. The item identification component 740 may be configured to support identifying a first set of items associated with the first product category that are depicted within the set of multiple images and that are visually similar to the query item. The item identification component 740 may be configured to support identifying, based on the second product category being complementary to the first product category, a second set of items associated with the second product category that are depicted together with the first set of items within the set of multiple images. The search result component 745 may be configured to support transmitting, to the client device in response to the query image, a search result that indicates one or more complementary items associated with the second product category that are available for purchase from the online marketplace, where the one or more complementary items comprise one or more items of the second set of items or one or more items that are visually similar to the second set of items.

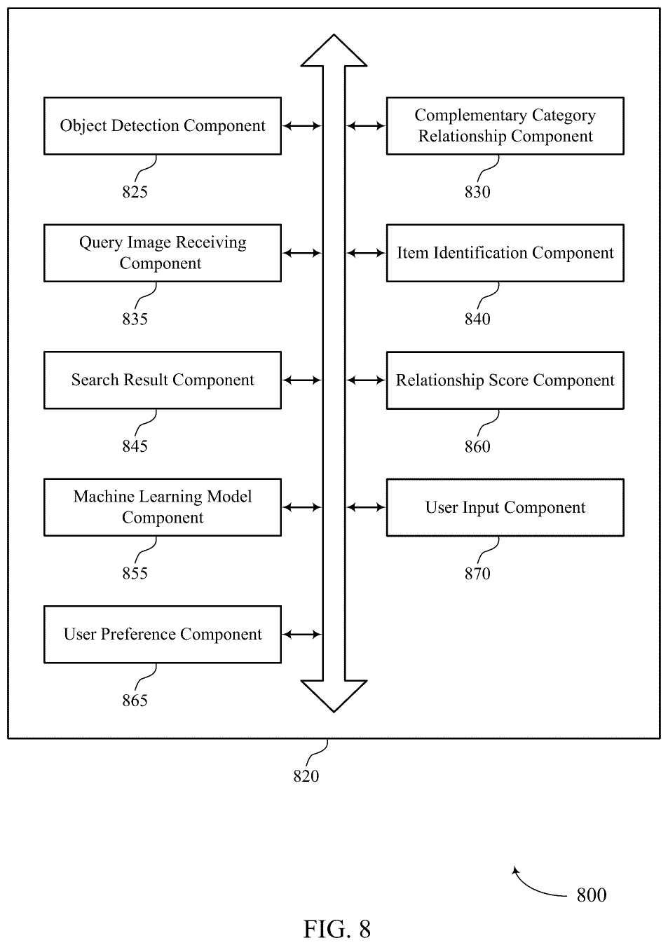

FIG. 8 shows a block diagram 800 of an automated visual conformance system 820 that supports data-driven automated visual conformance estimation for complementary item discovery in e-commerce in accordance with aspects of the present disclosure. The automated visual conformance system 820 may be an example of aspects of an item recommendation component 720, or both, as described herein. In some aspects, the automated visual conformance system 820 illustrated in FIG. 8 may be an example of the automated visual conformance system 145 illustrated in FIG. 1. The automated visual conformance system 820, or various components thereof, may be an example of means for performing various aspects of data-driven automated visual conformance estimation for complementary item discovery in e-commerce as described herein. For example, the automated visual conformance system 820 may include an object detection component 825, a complementary category relationship component 830, a query image receiving component 835, an item identification component 840, a search result component 845, a machine learning model component 855, a relationship score component 860, a user preference component 865, a user input component 870, or any combination thereof. Each of these components may communicate, directly or indirectly, with one another (e.g., via one or more buses).

The object detection component 825 may be configured to support identifying, using one or more processors, a set of multiple items depicted within a set of multiple images, where the set of multiple items are associated with a first product category and a second product category of a set of multiple product categories of an online marketplace. The complementary category relationship component 830 may be configured to support determining, using the one or more processors, a complementary category relationship between the first product category and the second product category based on a relative frequency that items associated with the first product category and the second product category are depicted together within the set of multiple images. The query image receiving component 835 may be configured to support receiving, from a client device, a query image depicting a query item associated with the first product category of the set of multiple product categories. In some examples, the complementary category relationship component 830 may be configured to support identifying that the first product category is complementary to the second product category of the set of multiple product categories based on the complementary category relationship. The item identification component 840 may be configured to support identifying a first set of items associated with the first product category that are depicted within the set of multiple images and that are visually similar to the query item. In some examples, the item identification component 840 may be configured to support identifying, based on the second product category being complementary to the first product category, a second set of items associated with the second product category that are depicted together with the first set of items within the set of multiple images. The search result component 845 may be configured to support transmitting, to the client device in response to the query image, a search result that indicates one or more complementary items associated with the second product category that are available for purchase from the online marketplace, where the one or more complementary items comprise one or more items of the second set of items or one or more items that are visually similar to the second set of items.

In some examples, the item identification component 840 may be configured to support determining a set of multiple appearances that indicate how often items associated with the respective set of multiple product categories are depicted within the set of multiple images. In some examples, the item identification component 840 may be configured to support determining the relative frequency that items associated with the first product category and the second product category are depicted together within the set of multiple images based on normalizing the set of multiple appearances, where determining the complementary category relationship is based on the relative frequency.

In some examples, the machine learning model component 855 may be configured to support generating, using a machine learning model, one or more data objects that indicate a set of multiple relative frequencies that items of respective pairs of product categories of the set of multiple product categories are depicted together within the set of multiple images, the set of multiple relative frequencies including the relative frequency between the first product category and the second product category. In some examples, the machine learning model component 855 may be configured to support referencing the one or more data objects based on receiving the query image, where identifying that the first product category is based on referencing the one or more data objects.

In some examples, the complementary category relationship component 830 may be configured to support determining a set of multiple complementary category relationships between the first product category and other product categories of the set of multiple product categories, the set of multiple complementary category relationships including the complementary category relationship. In some examples, the relationship score component 860 may be configured to support determining a set of multiple scores associated with the set of multiple complementary category relationships, where the set of multiple scores are associated with relative strengths of relationships between the first product category and the other product categories of the set of multiple product categories. In some examples, the complementary category relationship component 830 may be configured to support selecting the complementary category relationship from the set of multiple complementary category relationships based on the set of multiple scores, where identifying the first set of items and the second set of items is based on the complementary category relationship.

In some examples, the complementary category relationship between the first product category and the second product category is associated with a higher score as compared to an additional complementary category relationship between the first product category and a third product category based on items of the first product category being depicted together with items of the second product category more frequently than items of the third product category.

In some examples, the complementary category relationship is further generated based on purchasing history information associated with a relative frequency that items of the first product category and items of the second product category are purchased together via the online marketplace.

In some examples, the first set of items are visually similar to the query item based on the first set of items satisfying one or more visual similarity criteria. In some examples, the one or more visual similarity criteria include a color criteria, a stylistic criteria, a texture criteria, or any combination thereof.

In some examples, the user preference component 865 may be configured to support determining one or more user preferences of a user associated with the client device, where identifying the second set of items is based on the one or more user preferences.

In some examples, the user input component 870 may be configured to support receiving, from the client device, a request for complementary items associated with a third product category. In some examples, the item identification component 840 may be configured to support identifying, based on the request, a third set of items associated with the third product category that are depicted together with the first set of items within the set of multiple images. In some examples, the search result component 845 may be configured to support transmitting, to the client device in response to the query image, the search result that indicates one or more additional complementary items associated with the third product category that are available for purchase from the online marketplace, where the one or more additional complementary items comprise one or more items of the third set of items or one or more items that are visually similar to the third set of items.

In some examples, the user input component 870 may be configured to support receiving, via the client device, a selection of a complementary item of the one or more complementary items associated with the second product category. In some examples, the item identification component 840 may be configured to support identifying a third set of items associated with the second product category that are depicted within the set of multiple images and that are visually similar to the complementary item. In some examples, the item identification component 840 may be configured to support identifying, based on the second product category being complementary to a third product category, a fourth set of items associated with the third product category that are depicted together with the third set of items within the set of multiple images. In some examples, the search result component 845 may be configured to support transmitting, to the client device based on the selection, an additional search result that indicates one or more additional complementary items associated with the third product category that are available for purchase from the online marketplace, where the one or more additional complementary items comprise one or more items of the fourth set of items or one or more items that are visually similar to the fourth set of items.

FIG. 9 shows a diagram of a system 900 including a device 905 that supports data-driven automated visual conformance estimation for complementary item discovery in e-commerce in accordance with aspects of the present disclosure. The device 905 may be an example of or include the components of a device 705 as described herein. The device 905 may include components for bi-directional data communications including components for transmitting and receiving communications, such as an automated visual conformance system 920, an I/O controller 910, a database controller 915, a memory 925, a processor 930, and a database 935. These components may be in electronic communication or otherwise coupled (e.g., operatively, communicatively, functionally, electronically, electrically) via one or more buses (e.g., a bus 940). In some aspects, the automated visual conformance system 920 illustrated in FIG. 9 may be an example of the automated visual conformance system 145 illustrated in FIG. 1.

The I/O controller 910 may manage input signals 945 and output signals 950 for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. In other cases, the I/O controller 910 may represent or interact with a modem, a keyboard, a mouse, a touchscreen, or a similar device. In some cases, the I/O controller 910 may be implemented as part of a processor 930. In some examples, a user may interact with the device 905 via the I/O controller 910 or via hardware components controlled by the I/O controller 910.

The database controller 915 may manage data storage and processing in a database 935. In some cases, a user may interact with the database controller 915. In other cases, the database controller 915 may operate automatically without user interaction. The database 935 may be an example of a single database, a distributed database, multiple distributed databases, a data store, a data lake, or an emergency backup database.

Memory 925 may include random-access memory (RAM) and ROM. The memory 925 may store computer-readable, computer-executable software including instructions that, when executed, cause the processor 930 to perform various functions described herein. In some cases, the memory 925 may contain, among other things, a BIOS which may control basic hardware or software operation such as the interaction with peripheral components or devices.

The processor 930 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 930 may be configured to operate a memory array using a memory controller. In other cases, a memory controller may be integrated into the processor 930. The processor 930 may be configured to execute computer-readable instructions stored in a memory 925 to perform various functions (e.g., functions or tasks supporting data-driven automated visual conformance estimation for complementary item discovery in e-commerce).

For example, the automated visual conformance system 920 may be configured to support identifying, using one or more processors, a set of multiple items depicted within a set of multiple images, where the set of multiple items are associated with a first product category and a second product category of a set of multiple product categories of an online marketplace. The automated visual conformance system 920 may be configured to support determining, using the one or more processors, a complementary category relationship between the first product category and the second product category based on a relative frequency that items associated with the first product category and the second product category are depicted together within the set of multiple images. The automated visual conformance system 920 may be configured to support receiving, from a client device, a query image depicting a query item associated with the first product category of the set of multiple product categories. The automated visual conformance system 920 may be configured to support identifying that the first product category is complementary to the second product category of the set of multiple product categories based on the complementary category relationship. The automated visual conformance system 920 may be configured to support identifying a first set of items associated with the first product category that are depicted within the set of multiple images and that are visually similar to the query item. The automated visual conformance system 920 may be configured to support identifying, basing at least in part on the second product category being complementary to the first product category, a second set of items associated with the second product category that are depicted together with the first set of items within the set of multiple images. The automated visual conformance system 920 may be configured to support transmitting, to the client device in response to the query image, a search result that indicates one or more complementary items associated with the second product category that are available for purchase from the online marketplace, where the one or more complementary items comprise one or more items of the second set of items or one or more items that are visually similar to the second set of items.

For example, the automated visual conformance system 920 may be configured to support identifying a set of multiple items depicted within a set of multiple images, where the set of multiple items are associated with a first product category and a second product category of a set of multiple product categories of an online marketplace. The automated visual conformance system 920 may be configured to support determining a complementary category relationship between the first product category and the second product category based on a relative frequency that items associated with the first product category and the second product category are depicted together within the set of multiple images. The automated visual conformance system 920 may be configured to support receiving, from a client device, a query image depicting a query item associated with the first product category of the set of multiple product categories. The automated visual conformance system 920 may be configured to support identifying that the first product category is complementary to the second product category of the set of multiple product categories based on the complementary category relationship. The automated visual conformance system 920 may be configured to support identifying a first set of items associated with the first product category that are depicted within the set of multiple images and that are visually similar to the query item. The automated visual conformance system 920 may be configured to support identifying, based on the second product category being complementary to the first product category, a second set of items associated with the second product category that are depicted together with the first set of items within the set of multiple images. The automated visual conformance system 920 may be configured to support transmitting, to the client device in response to the query image, a search result that indicates one or more complementary items associated with the second product category that are available for purchase from the online marketplace, where the one or more complementary comprise one or more items of the second set of items or one or more items that are visually similar to the second set of items.

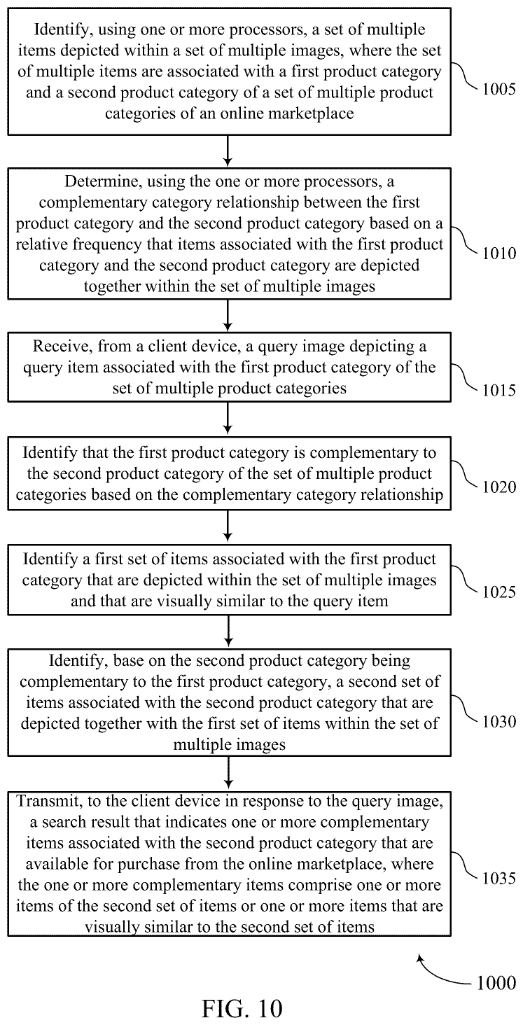

FIG. 10 shows a flowchart illustrating a method 1000 that supports data-driven automated visual conformance estimation for complementary item discovery in e-commerce in accordance with aspects of the present disclosure. The operations of the method 1000 may be implemented by a server device or its components as described herein. For example, the operations of the method 1000 may be performed by a server device as described with reference to FIGS. 1 through 9. Additionally, or alternatively, the server device may perform aspects of the described functions using special-purpose hardware.

At 1005, the method may include identifying, using one or more processors, a set of multiple items depicted within a set of multiple images, where the set of multiple items are associated with a first product category and a second product category of a set of multiple product categories of an online marketplace. The operations of 1005 may be performed in accordance with examples as disclosed herein. In some examples, aspects of the operations of 1005 may be performed by an object detection component 825 as described with reference to FIG. 8.

At 1010, the method may include determining, using the one or more processors, a complementary category relationship between the first product category and the second product category based on a relative frequency that items associated with the first product category and the second product category are depicted together within the set of multiple images. The operations of 1010 may be performed in accordance with examples as disclosed herein. In some examples, aspects of the operations of 1010 may be performed by a complementary category relationship component 830 as described with reference to FIG. 8.

At 1015, the method may include receiving, from a client device, a query image depicting a query item associated with the first product category of the set of multiple product categories. The operations of 1015 may be performed in accordance with examples as disclosed herein. In some examples, aspects of the operations of 1015 may be performed by a query image receiving component 835 as described with reference to FIG. 8.

At 1020, the method may include identifying that the first product category is complementary to the second product category of the set of multiple product categories based on the complementary category relationship. The operations of 1020 may be performed in accordance with examples as disclosed herein. In some examples, aspects of the operations of 1020 may be performed by a complementary category relationship component 830 as described with reference to FIG. 8.

At 1025, the method may include identifying a first set of items associated with the first product category that are depicted within the set of multiple images and that are visually similar to the query item. The operations of 1025 may be performed in accordance with examples as disclosed herein. In some examples, aspects of the operations of 1025 may be performed by an item identification component 840 as described with reference to FIG. 8.

At 1030, the method may include identifying, based on the second product category being complementary to the first product category, a second set of items associated with the second product category that are depicted together with the first set of items within the set of multiple images. The operations of 1030 may be performed in accordance with examples as disclosed herein. In some examples, aspects of the operations of 1030 may be performed by an item identification component 840 as described with reference to FIG. 8.

At 1035, the method may include transmitting, to the client device in response to the query image, a search result that indicates one or more complementary items associated with the second product category that are available for purchase from the online marketplace, where the one or more complementary items comprise one or more items of the second set of items and/or one or more items that are visually similar to the second set of items. The operations of 1035 may be performed in accordance with examples as disclosed herein. In some examples, aspects of the operations of 1035 may be performed by a search result component 845 as described with reference to FIG. 8.

The following provides an overview of aspects of the present disclosure:

Aspect 1: A computer-implemented method, comprising: identifying, using one or more processors, a plurality of items depicted within a plurality of images, wherein the plurality of items are associated with a first product category and a second product category of a plurality of product categories of an online marketplace: determining, using the one or more processors, a complementary category relationship between the first product category and the second product category based at least in part on a relative frequency that items associated with the first product category and the second product category are depicted together within the plurality of images: receiving, from a client device, a query image depicting a query item associated with the first product category of the plurality of product categories: identifying that the first product category is complementary to the second product category of the plurality of product categories based at least in part on the complementary category relationship: identifying a first set of items associated with the first product category that are depicted within the plurality of images and that are visually similar to the query item; identifying, based at least in part on the second product category being complementary to the first product category, a second set of items associated with the second product category that are depicted together with the first set of items within the plurality of images; and transmitting, to the client device in response to the query image, a search result that indicates one or more complementary items associated with the second product category that are available for purchase from the online marketplace, wherein the one or more complementary items comprise one or more items of the second set of items and/or one or more items that are visually similar to the second set of items.

Aspect 2: The computer-implemented method of aspect 1, further comprising: determining a plurality of appearances that indicate how often items associated with the respective plurality of product categories are depicted within the plurality of images; and determining the relative frequency that items associated with the first product category and the second product category are depicted together within the plurality of images based at least in part on normalizing the plurality of appearances, wherein determining the complementary category relationship is based at least in part on the relative frequency.

Aspect 3: The computer-implemented method of any of aspects 1 through 2, further comprising: generating, using a machine learning model, one or more data objects that indicate a plurality of relative frequencies that items of respective pairs of product categories of the plurality of product categories are depicted together within the plurality of images, the plurality of relative frequencies including the relative frequency between the first product category and the second product category; and referencing the one or more data objects based at least in part on receiving the query image, wherein identifying that the first product category is based at least in part on referencing the one or more data objects.

Aspect 4: The computer-implemented method of any of aspects 1 through 3, further comprising: determining a plurality of complementary category relationships between the first product category and other product categories of the plurality of product categories, the plurality of complementary category relationships including the complementary category relationship: determining a plurality of scores associated with the plurality of complementary category relationships, wherein the plurality of scores are associated with relative strengths of relationships between the first product category and the other product categories of the plurality of product categories; and selecting the complementary category relationship from the plurality of complementary category relationships based at least in part on the plurality of scores, wherein identifying the first set of items and the second set of items is based at least in part on the complementary category relationship.

Aspect 5: The computer-implemented method of aspect 4, wherein the complementary category relationship between the first product category and the second product category is associated with a higher score as compared to an additional complementary category relationship between the first product category and a third product category based at least in part on items of the first product category being depicted together with items of the second product category more frequently than items of the third product category.

Aspect 6: The computer-implemented method of any of aspects 1 through 5, wherein the complementary category relationship is further generated based at least in part on purchasing history information associated with a relative frequency that items of the first product category and items of the second product category are purchased together via the online marketplace.

Aspect 7: The computer-implemented method of any of aspects 1 through 6, wherein the first set of items are visually similar to the query item based at least in part on the first set of items satisfying one or more visual similarity criteria, the one or more visual similarity criteria comprise a color criteria, a stylistic criteria, a texture criteria, or any combination thereof.

Aspect 8: The computer-implemented method of any of aspects 1 through 7, further comprising: determining one or more user preferences of a user associated with the client device, wherein identifying the second set of items is based at least in part on the one or more user preferences.

Aspect 9: The computer-implemented method of any of aspects 1 through 8, further comprising: receiving, from the client device, a request for complementary items associated with a third product category: identifying, based at least in part on the request, a third set of items associated with the third product category that are depicted together with the first set of items within the plurality of images; and transmitting, to the client device in response to the query image, the search result that indicates one or more additional complementary items associated with the third product category that are available for purchase from the online marketplace, wherein the one or more additional complementary items comprise one or more items of the third set of items or one or more items that are visually similar to the third set of items.

Aspect 10: The computer-implemented method of any of aspects 1 through 9, further comprising: receiving, via the client device, a selection of a complementary item of the one or more complementary items associated with the second product category; identifying a third set of items associated with the second product category that are depicted within the plurality of images and that are visually similar to the complementary item; identifying, based at least in part on the second product category being complementary to a third product category, a fourth set of items associated with the third product category that are depicted together with the third set of items within the plurality of images; and transmitting, to the client device based at least in part on the selection, an additional search result that indicates one or more additional complementary items associated with the third product category that are available for purchase from the online marketplace, wherein the one or more additional complementary items comprise one or more items of the fourth set of items or one or more items that are visually similar to the fourth set of items.

Aspect 11: An apparatus comprising at least one processor: memory coupled with the at least one processor; and instructions stored in the memory and executable by the at least one processor to cause the apparatus to perform a method of any of aspects 1 through 10.

Aspect 12: An apparatus comprising at least one means for performing a method of any of aspects 1 through 10.

Aspect 13: A non-transitory computer-readable medium storing code the code comprising instructions executable by at least one processor to cause a system or apparatus perform a method of any of aspects 1 through 10.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration), wherein a processor, or a group of processors, may individually, respectively, or collectively, perform any of the functions discussed herein.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A computer-implemented method, comprising:
identifying, using one or more processors, a plurality of items depicted within a plurality of images, wherein the plurality of items are associated with a first product category and a second product category of a plurality of product categories of an online marketplace:
determining, using the one or more processors, a complementary category relationship between the first product category and the second product category based at least in part on a relative frequency that items associated with the first product category and the second product category are depicted together within the plurality of images:
receiving, from a client device, a query image depicting a query item associated with the first product category of the plurality of product categories:
identifying that the first product category is complementary to the second product category of the plurality of product categories based at least in part on the complementary category relationship:
identifying a first set of items associated with the first product category that are depicted within the plurality of images and that are visually similar to the query item:
identifying, based at least in part on the second product category being complementary to the first product category, a second set of items associated with the second product category that are depicted together with the first set of items within the plurality of images; and
transmitting, to the client device in response to the query image, a search result that indicates one or more complementary items associated with the second product category that are available for purchase from the online marketplace, wherein the one or more complementary items comprise one or more items of the second set of items or one or more items that are visually similar to the second set of items.

2. The computer-implemented method of claim 1, further comprising:
determining a plurality of appearances that indicate how often items associated with respective product categories are depicted together within the plurality of images; and
determining the relative frequency that items associated with the first product category and the second product category are depicted together within the plurality of images based at least in part on normalizing the plurality of appearances, wherein determining the complementary category relationship is based at least in part on the relative frequency.

3. The computer-implemented method of claim 1, further comprising:
generating, using a machine learning model, one or more data objects that indicate a plurality of relative frequencies that items of respective pairs of product categories of the plurality of product categories are depicted together within the plurality of images, the plurality of relative frequencies including the relative frequency between the first product category and the second product category; and
referencing the one or more data objects based at least in part on receiving the query image, wherein identifying that the first product category is based at least in part on referencing the one or more data objects.

4. The computer-implemented method of claim 1, further comprising:
determining a plurality of complementary category relationships between the first product category and other product categories of the plurality of product categories, the plurality of complementary category relationships including the complementary category relationship:
determining a plurality of scores associated with the plurality of complementary category relationships, wherein the plurality of scores are associated with relative strengths of relationships between the first product category and the other product categories of the plurality of product categories; and
selecting the complementary category relationship from the plurality of complementary category relationships based at least in part on the plurality of scores, wherein identifying the first set of items and the second set of items is based at least in part on the complementary category relationship.

5. The computer-implemented method of claim 4, wherein the complementary category relationship between the first product category and the second product category is associated with a higher score as compared to an additional complementary category relationship between the first product category and a third product category based at least in part on items of the first product category being depicted together with items of the second product category more frequently than items of the third product category.

6. The computer-implemented method of claim 1, wherein the complementary category relationship is further generated based at least in part on purchasing history information associated with a relative frequency that items of the first product category and items of the second product category are purchased together via the online marketplace.

7. The computer-implemented method of claim 1, wherein the first set of items are visually similar to the query item based at least in part on the first set of items satisfying one or more visual similarity criteria, wherein the one or more visual similarity criteria comprise a color criteria, a stylistic criteria, a texture criteria, or any combination thereof.

8. The computer-implemented method of claim 1, further comprising:
determining one or more user preferences of a user associated with the client device, wherein identifying the second set of items is based at least in part on the one or more user preferences.

9. The computer-implemented method of claim 1, further comprising:
receiving, from the client device, a request for complementary items associated with a third product category:
identifying, based at least in part on the request, a third set of items associated with the third product category that are depicted together with the first set of items within the plurality of images; and
transmitting, to the client device in response to the query image, the search result that indicates one or more additional complementary items associated with the third product category that are available for purchase from the online marketplace, wherein the one or more additional complementary items comprise one or more items of the third set of items or one or more items that are visually similar to the third set of items.

10. The computer-implemented method of claim 1, further comprising:
receiving, via the client device, a selection of a complementary item of the one or more complementary items associated with the second product category:
identifying a third set of items associated with the second product category that are depicted within the plurality of images and that are visually similar to the complementary item:
identifying, based at least in part on the second product category being complementary to a third product category, a fourth set of items associated with the third product category that are depicted together with the third set of items within the plurality of images; and
transmitting, to the client device based at least in part on the selection, an additional search result that indicates one or more additional complementary items associated with the third product category that are available for purchase from the online marketplace, wherein the one or more additional complementary items comprise one or more items of the fourth set of items or one or more items that are visually similar to the fourth set of items.

11. A system, comprising:
at least one processor:
memory coupled with the at least one processor; and
instructions stored in the memory and executable by the at least one processor to cause the system to:
identify a plurality of items depicted within a plurality of images, wherein the plurality of items are associated with a first product category and a second product category of a plurality of product categories of an online marketplace:
determine a complementary category relationship between the first product category and the second product category based at least in part on a relative frequency that items associated with the first product category and the second product category are depicted together within the plurality of images:
receive, from a client device, a query image depicting a query item associated with the first product category of the plurality of product categories:
identify that the first product category is complementary to the second product category of the plurality of product categories based at least in part on the complementary category relationship:
identify a first set of items associated with the first product category that are depicted within the plurality of images and that are visually similar to the query item:
identify, based at least in part on the second product category being complementary to the first product category, a second set of items associated with the second product category that are depicted together with the first set of items within the plurality of images; and
transmit, to the client device in response to the query image, a search result that indicates one or more complementary items associated with the second product category that are available for purchase from the online marketplace, wherein the one or more complementary items comprise one or more items of the second set of items or one or more items that are visually similar to the second set of items.

12. The system of claim 11, wherein the instructions are further executable by the at least one processor to cause the system to:
determine a plurality of appearances that indicate how often items associated with respective product categories are depicted together within the plurality of images; and
determine the relative frequency that items associated with the first product category and the second product category are depicted together within the plurality of images based at least in part on normalizing the plurality of appearances, wherein determining the complementary category relationship is based at least in part on the relative frequency.

13. The system of claim 11, wherein the instructions are further executable by the at least one processor to cause the system to:
generate, using a machine learning model, one or more data objects that indicate a plurality of relative frequencies that items of respective pairs of product categories of the plurality of product categories are depicted together within the plurality of images, the plurality of relative frequencies including the relative frequency between the first product category and the second product category; and
reference the one or more data objects based at least in part on receiving the query image, wherein identifying that the first product category is based at least in part on referencing the one or more data objects.

14. The system of claim 11, wherein the instructions are further executable by the at least one processor to cause the system to:
determine a plurality of complementary category relationships between the first product category and other product categories of the plurality of product categories, the plurality of complementary category relationships including the complementary category relationship:
determine a plurality of scores associated with the plurality of complementary category relationships, wherein the plurality of scores are associated with relative strengths of relationships between the first product category and the other product categories of the plurality of product categories; and
select the complementary category relationship from the plurality of complementary category relationships based at least in part on the plurality of scores, wherein identifying the first set of items and the second set of items is based at least in part on the complementary category relationship.

15. The system of claim 14, wherein the complementary category relationship between the first product category and the second product category is associated with a higher score as compared to an additional complementary category relationship between the first product category and a third product category based at least in part on items of the first product category being depicted together with items of the second product category more frequently than items of the third product category.

16. The system of claim 11, wherein the complementary category relationship is further generated based at least in part on purchasing history information associated with a relative frequency that items of the first product category and items of the second product category are purchased together via the online marketplace.

17. The system of claim 11, wherein the first set of items are visually similar to the query item based at least in part on the first set of items satisfying one or more visual similarity criteria, and wherein the one or more visual similarity criteria comprise a color criteria, a stylistic criteria, a texture criteria, or any combination thereof.

18. The system of claim 11, wherein the instructions are further executable by the at least one processor to cause the system to:
determine one or more user preferences of a user associated with the client device, wherein identifying the second set of items is based at least in part on the one or more user preferences.

19. The system of claim 11, wherein the instructions are further executable by the at least one processor to cause the system to:
receive, from the client device, a request for complementary items associated with a third product category:
identify, based at least in part on the request, a third set of items associated with the third product category that are depicted together with the first set of items within the plurality of images; and
transmit, to the client device in response to the query image, the search result that indicates one or more additional complementary items associated with the third product category that are available for purchase from the online marketplace, wherein the one or more additional complementary items comprise one or more items of the third set of items or one or more items that are visually similar to the third set of items.

20. A non-transitory computer-readable medium storing code, the code comprising instructions executable by at least one processor to cause a system to:
identify a plurality of items depicted within a plurality of images, wherein the plurality of items are associated with a first product category and a second product category of a plurality of product categories of an online marketplace:
determine a complementary category relationship between the first product category and the second product category based at least in part on a relative frequency that items associated with the first product category and the second product category are depicted together within the plurality of images:
receive, from a client device, a query image depicting a query item associated with the first product category of the plurality of product categories:
identify that the first product category is complementary to the second product category of the plurality of product categories based at least in part on the complementary category relationship:
identify a first set of items associated with the first product category that are depicted within the plurality of images and that are visually similar to the query item:
identify, based at least in part on the second product category being complementary to the first product category, a second set of items associated with the second product category that are depicted together with the first set of items within the plurality of images; and
transmit, to the client device in response to the query image, a search result that indicates one or more complementary items associated with the second product category that are available for purchase from the online marketplace, wherein the one or more complementary items comprise one or more items of the second set of items or one or more items that are visually similar to the second set of items.
